(19) United States
(12) Patent Application Publication
(10) Pub. No.: US 2002/0103689 A1
(43) Pub. Date: Aug. 1, 2002

(54) Methods and systems for identifying prospective customers and managing deals

(76) Inventors: Randall F. Hornick, Darien, CT (US); Enrique Alfonso Campalans, Easton, CT (US); Stacey M. Goodwin, Norwalk, CT (US); Kevin M. McCarthy, Shelton, CT (US); Gabrielle Nicole McConnell, Wilbraham, MA (US); Michael W. Paiko, Stamford, CT (US); Kevin Patrick Walsh, Fairfield, CT (US); Dawn A. Sadler, New Milford, CT (US); Teresa G. Carter, Trumbull, CT (US); Richard M. Alexander, Trumbull, CT (US); Judith W. Kurzner, Westport, CT (US); Janice Pearson, Stamford, CT (US); James P. Gillies, Trumbull, CT (US)

Correspondence Address: John S. Beulick, Armstrong Teasdale LLP, One Metropolitan Sq., Suite 2600, St. Louis, MO, 63102, US

(21) Appl. No.: 09/771,358

(22) Filed: Jan. 27, 2001

(51) Int. Cl. G06F 17/60

(52) U.S. Cl. 705/9

(57) ABSTRACT

A method for supporting, streamlining and standardizing a deal-making process using a deal managing and processing system includes the steps of creating a new deal profile, creating a deal prospect user interface, updating a status of prospects based upon a prospects response and using system based tool to guide a deal team through the deal-making process. In one embodiment, personal portals are configured for prospective customers to access deal information. In another embodiment, personalized web pages are configured to attract prospects for business.

### BACKGROUND OF THE INVENTION

This invention relates generally to deal origination and management, and more specifically to methods and systems for customer prospecting, deal making and closing deals with customers.

Identifying prospective customers can be a time consuming and difficult task, especially for a large organization. For example, if many different products and services are offered by one organization, simply identifying the needs of prospective customers and whether such needs can be met by any of the offered products and services can require significant resources. Also, and in a large organization, communicating the efforts that have been made with respect to each prospective customer throughout the organization can be difficult in that many people can be involved in the deal origination efforts. Therefore, significant time and resources can be required to coordinate the internal efforts being directed toward each prospective customer to ensure that timely and meaningful information is provided and also to ensure that such efforts are not being duplicated elsewhere within the organization.

Once a prospective customer has been identified, a further challenge lies in maintaining contact with such prospective customer and ensuring that such contacts are meaningful and of interest. Each prospective customer typically is not interested in the full array of products and services that may be offered by a large organization. If the organization continuously contacts the prospective customer regarding products and services that are of no interest, such contacts can be annoying and result in an unintended effect. That is, the prospective customer can quickly lose interest in dealing with the organization.

If a prospective customer indicates an interest in purchasing a product or service of the organization, it then becomes necessary for the organization to deliver based on the expectations that have been created during the selling process. Of course, failing to meet the expectations of a prospective customer can result in not only the loss of a sale, but also a loss of goodwill. Successfully complete a transaction with an opportunity for repeat business is facilitated by ensuring that tasks associated with completing the deal are completed on time. In order to ensure tasks are completed on time, each individual involved in the closing should clearly understand his or her role in completing each task and the date such task is to be completed. Such communication and effective management of deal closing can be challenging, especially if many deals are being handled at a given time and numerous individuals are involved.

### BRIEF SUMMARY OF THE INVENTION

In one aspect, a method for supporting, streamlining and standardizing a deal-making process is provided. The method, in an exemplary embodiment, includes the steps of creating business profiles, creating a deal prospect user interface, updating a status of prospects based upon a prospects response, and using a system based tool to guide a deal team through the deal-making process.

In another aspect, a system configured for managing the deal process is provided. The system includes templates for deal creation and libraries to store documents which are associated with a deal. The templates facilitate ensuring a common approach for deal creation and management across a business while allowing for business specific customization. The system also provides for identification of pre-defined tasks and includes structures for facilitating business transactions which allow individual business units to configure portals and web pages to meet business needs. The system includes a robust security structure allowing companies and users on specific deals to be isolated from other deals, thereby protecting company confidential information. Also, summary and status pages within the system keep members of a deal team informed.

### BRIEF DESCRIPTION OF THE DRAWINGS

FIG. 1 is a flowchart identifying alternative interfaces used to attract prospects for deals;

FIG. 2 is a simplified system diagram;

FIG. 3 is a diagram of a networked system;

FIG. 4 is a diagram depicting a deal process;

FIG. 5 is an exemplary business profile screen;

FIG. 6 is an exemplary business hierarchy screen;

FIG. 7 is an exemplary create division profile screen;

FIG. 8 is an exemplary create sub-division profile screen;

FIG. 9 is an exemplary library template screen;

FIG. 10 is an exemplary create/modify library template screen;

FIG. 11 is an exemplary create/modify library template folder screen;

FIG. 12 is an exemplary view templates screen;

FIG. 13 is an exemplary create/modify template screen;

FIG. 14 is an exemplary create deal screen;

FIG. 15 is an exemplary deal summary screen;

FIG. 16 is an exemplary deal list screen;

FIG. 17 is an exemplary work group screen;

FIG. 18 is an exemplary select company screen;

FIG. 19 is an exemplary company relationships screen;

FIG. 20 is an exemplary select team members screen;

FIG. 21 is an exemplary of a my profile screen;

FIG. 22 is an exemplary user profiles screen;

FIG. 23 is an exemplary user profile pop-up window;

FIG. 24 is an exemplary company profile screen;

FIG. 25 is an exemplary company profile pop-up window;

FIG. 26 is an exemplary briefing page;

FIG. 27 is an exemplary create/modify milestone screen;

FIG. 28 is an exemplary create/modify milestone screen;

FIG. 29 is an exemplary create/modify task screen;

FIG. 30 is an exemplary create/modify task screen;

FIG. 31 is an exemplary create/modify sub-task screen;

FIG. 32 is an exemplary task assignment screen;

FIG. 33 is an exemplary task notifications screen;

FIG. 34 is an exemplary tasks/timelines screen;

FIG. 35 is an exemplary create discussion screen;

FIG. 36 is an exemplary view discussion screen;

FIG. 37 is an exemplary voice of customer submit screen;

FIG. 38 is an exemplary voice of customer submitted screen;

FIG. 39 is an exemplary voice of customer summary screen;

FIG. 40 is an exemplary view library screen;

FIG. 41 is an exemplary create folder screen;

FIG. 42 is an exemplary create index card screen;

FIG. 43 is an exemplary modify index card screen;

FIG. 44 is an exemplary create deal profiles screen;

FIG. 45 is an exemplary view deal profiles screen;

FIG. 46 is an exemplary deal search preferences screen;

FIG. 47 is an exemplary deal search results screen;

FIG. 48 is an exemplary customer invitation screen;

FIG. 49 is a continuation of a customer invitation screen;

FIG. 50 is an exemplary originator home page.

FIG. 51 is an exemplary originator setup page.

FIG. 52 is an exemplary prospect home page.

FIG. 53 is an exemplary customer home page;

FIG. 54 is an exemplary intermediary home page; and

FIG. 55 is an exemplary example of a home page activity report.

### DETAILED DESCRIPTION OF THE INVENTION

Set forth below is a description of exemplary methods and systems for facilitating origination of new business and tracking transactions. More specifically, and in an exemplary embodiment, the system includes multiple interfaces to facilitate customer prospecting, including webpages which attract prospects and personalized customer portals. The webpages can be customized as prospects become customers. The personalized customer portals also are customized and directed towards inviting a customer to become part of a deal team. Once a customer is part of a deal team, the system allows an administrator to fashion business rules, permission levels, security, tasks/milestones, document management and deal management for the customer deal team members and internal deal team members.

Supervisors, deal managers and deal participants, with appropriate permission attributes, can utilize the system, for example, to obtain all pertinent information associated with a deal. The system also facilitates prompt creation of a new deal once a prospective customer identifies a deal. For example, using the system a deal team can be identified, tasks can be scheduled and assigned, and documents can be associated with the deal. For example, a deal manager determines which aspects of a deal are shared with internal team members or external partners or clients. The deal manager or deal participants therefore can create a threaded discussion that is only viewable by internal team members.

The exemplary system also provides flexibility and functionality so that different business entities within a company can support, streamline and standardize their deal processes. For example, task and library templates stored within the system allow the businesses to predefine the content management structures required for their unique business transactions and enable workflow unique to each business. In another example, a business unit configuration module enables each business to configure the system with customer interfaces to suit its business needs. The business modules allow a business to “turn on/off” different components of functionality, as well as predefine global deal visibility rules within the customer interface.

The system facilitates productivity improvement for a company and its customers as current transaction-based business processes are digitized, by eliminating the inefficiencies in handling and moving paper. Removing inefficiencies facilitates a potential revenue enhancement and an achievement of a competitive advantage by providing personalized transaction dealings with customers, and an ability to leverage a corporate knowledge base through digitized processes and resources. Further gains are realized by providing a common technology platform throughout a company.

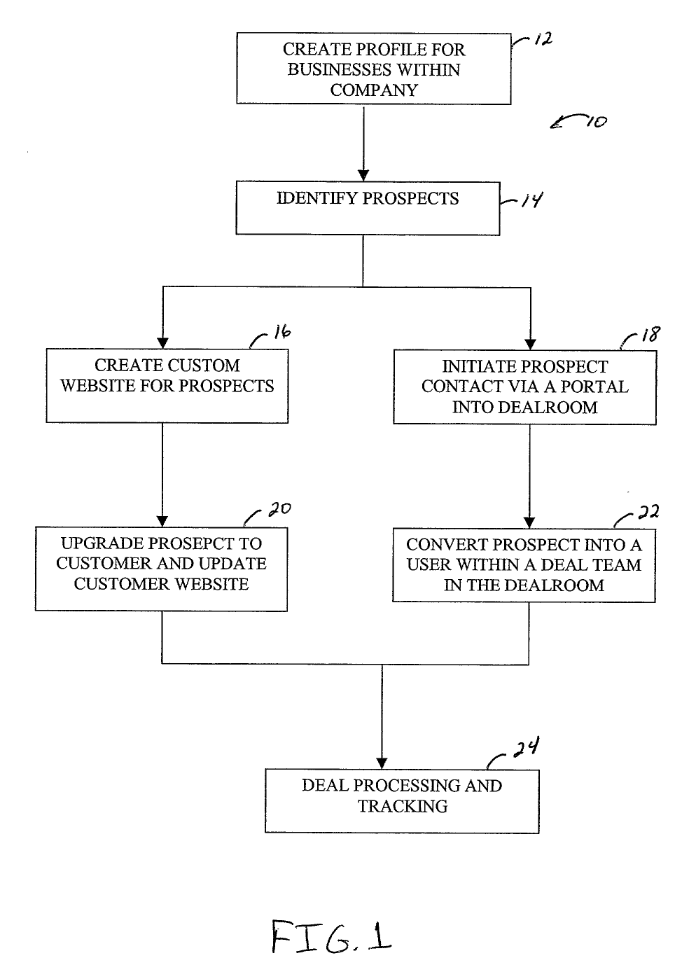

FIG. 1 is a flow chart 10 illustrating process steps for one exemplary method for facilitating and tracking business and business prospects, and turning prospects into customers. Referring specifically to FIG. 1, a business profile for a business is created 12, after which a user identifies 14 prospects for the business. In alternate embodiments, based on prospect information, a customized web page is created 16 for prospects, where prospective customers will access the web-page or creates 18 a personalized portal where a prospect, which has been contacted earlier and has shown some interest, can become an authorized user of the system, and part of a deal team.

In the embodiment where a web page is created 16, the prospect views the web page, which contains customized information from an originator, and if the prospect shows an interest in any of the products in the prospect page, by selecting any of various links shown on the page, the system will upgrade 20 the prospect to a customer. Based upon the initiated contact from the prospect, a customized customer web page, which includes content of interest to the prospect, is created and directed toward deal initiation. Alternatively, where the prospect is contacted through the personalized portal, and there is interest in deal making on the part of the prospect, the prospect is registered 22 as a user within the system.

Whether a prospect becomes a user via web page access or through contact and the development of a personalized portal, once the deal process has been initiated, deal management and processing is accomplished 24 using the system. Examples of products which are managed and processed using the system include, but are not limited to loans, leases, equity stakes and common equity. Examples within the loan category include construction loans, development loans, letters of credit, loan participation, revolver, senior loans, subordinated loans and U.S. tax exempt debt. Leases include single investor leases, leveraged leases, and off balance sheet loans. Equity and common equity further include equity, limited partnerships, limited partnership—tax credit deals, marketable securities, preferred limited partnerships, preferred stock, common stock, construction equity, development equity, and fund equity.

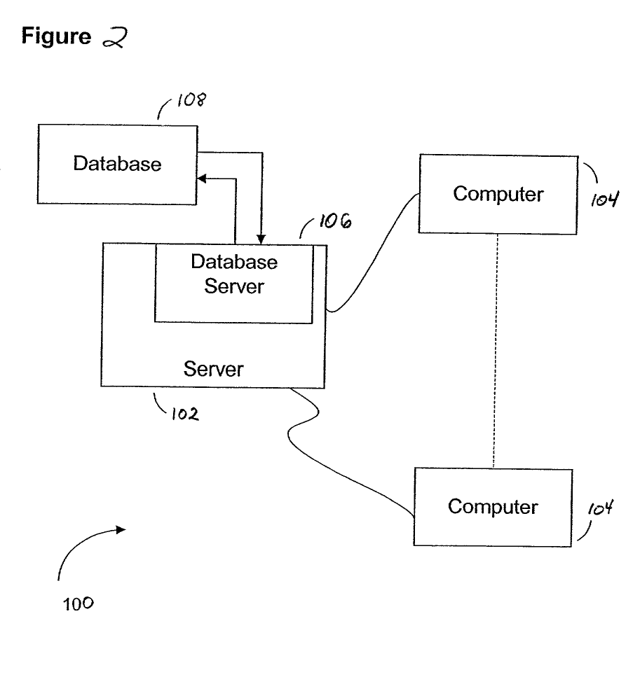

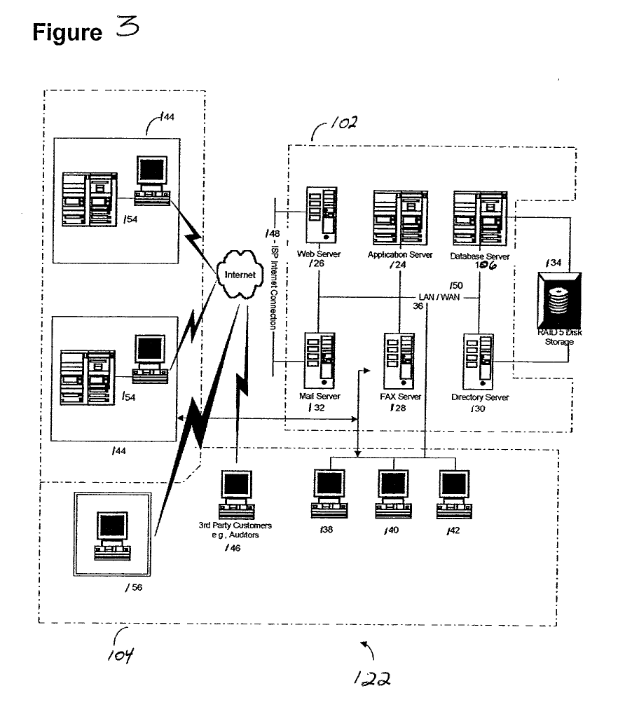

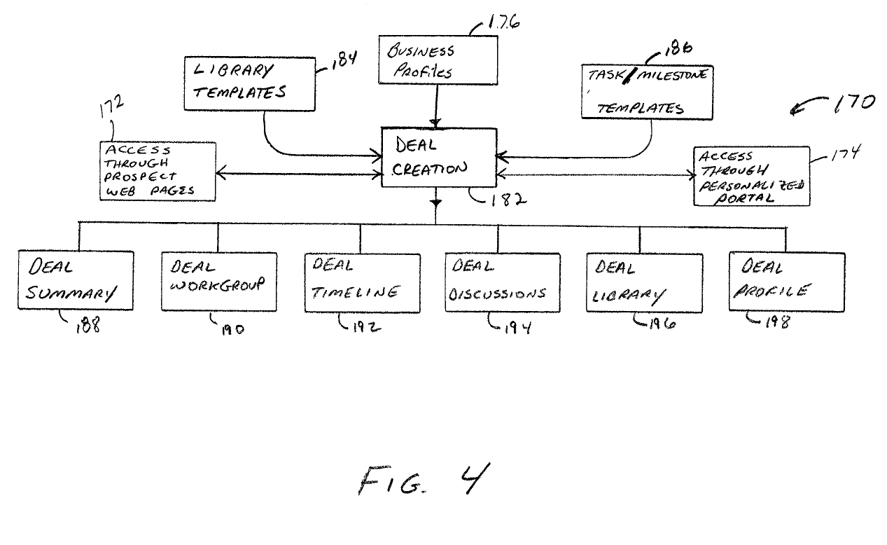

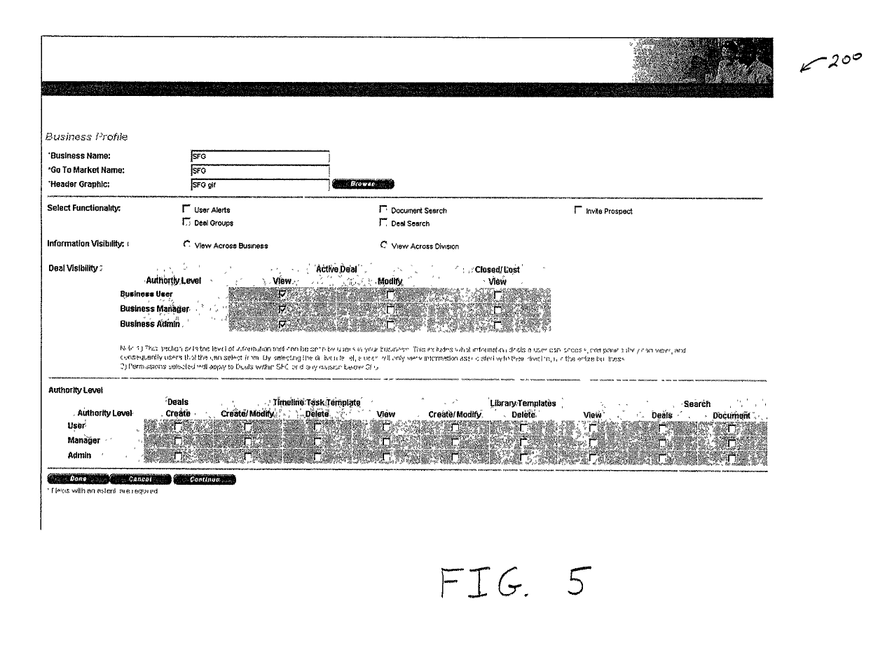

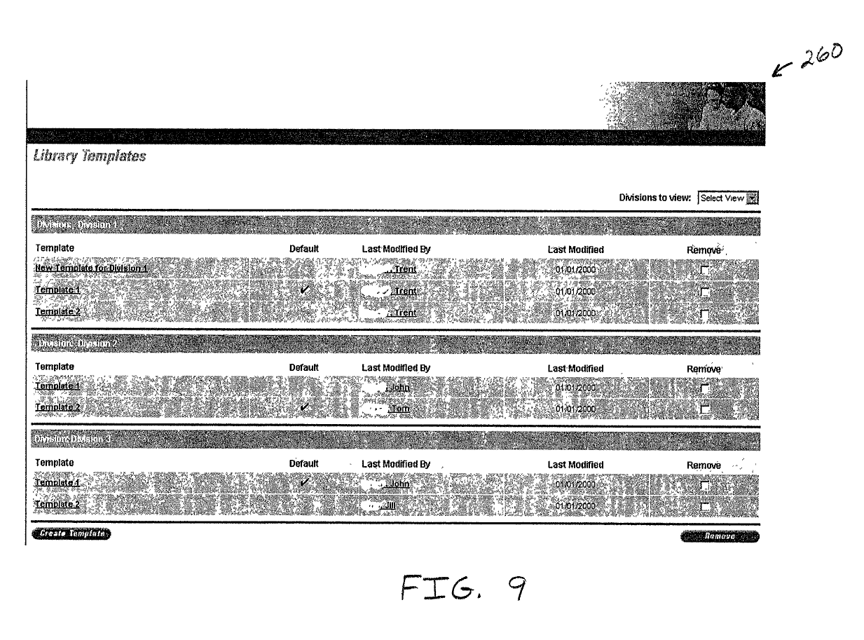

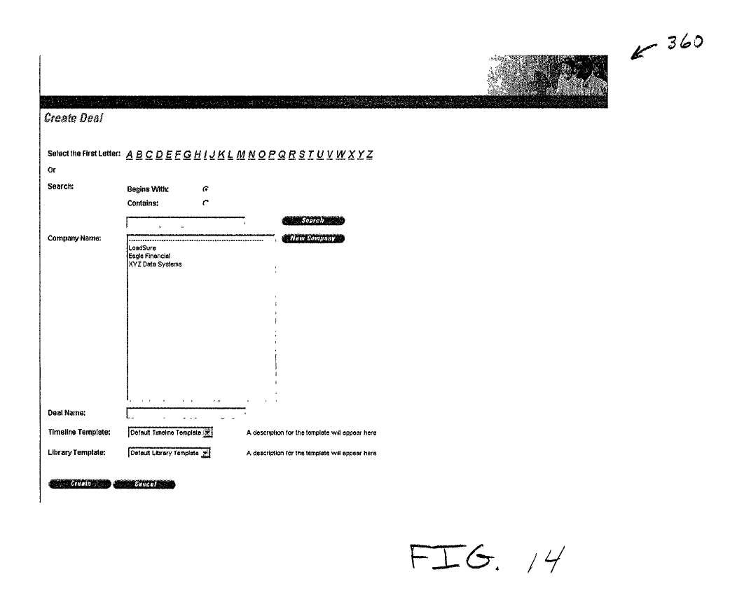

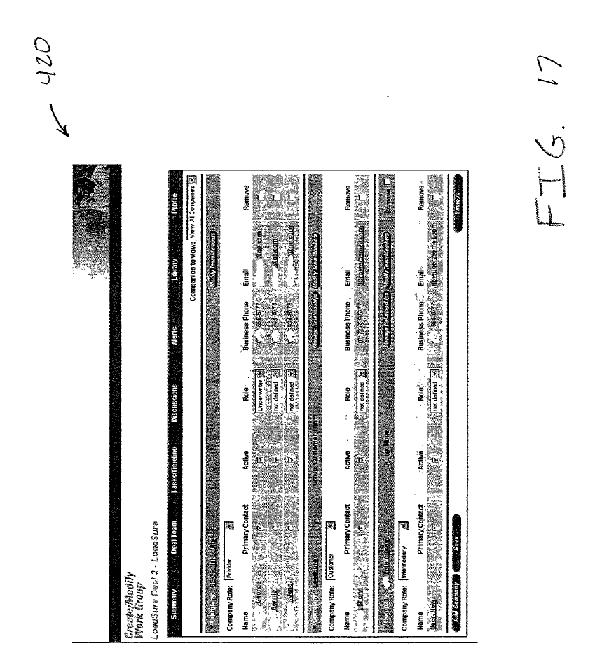

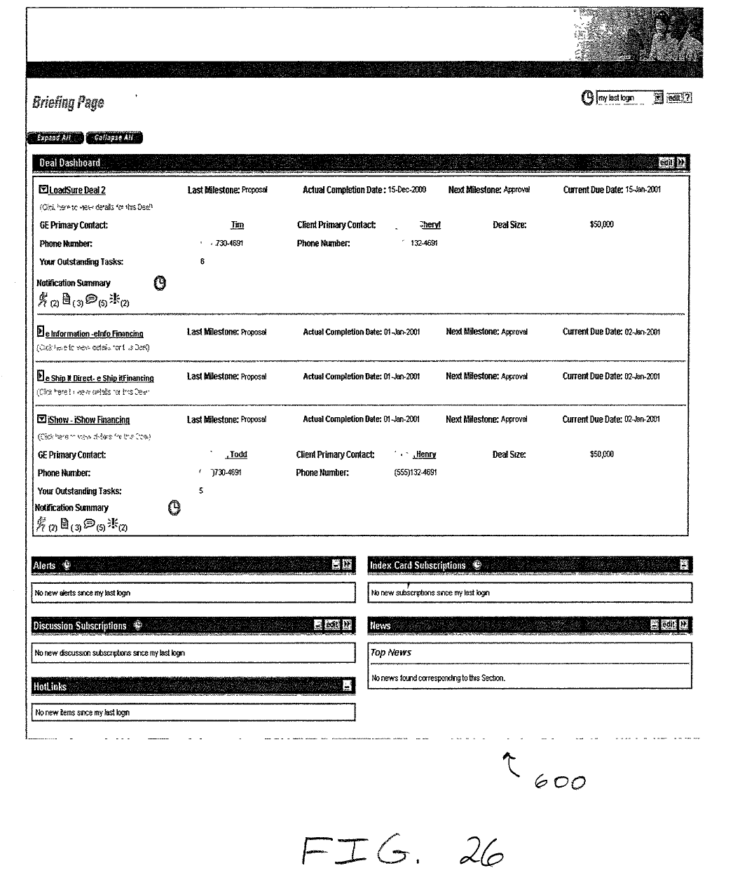

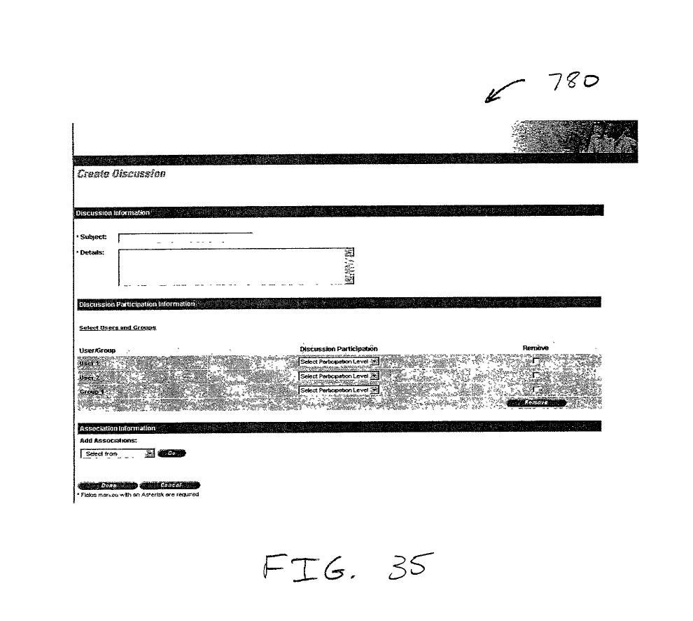

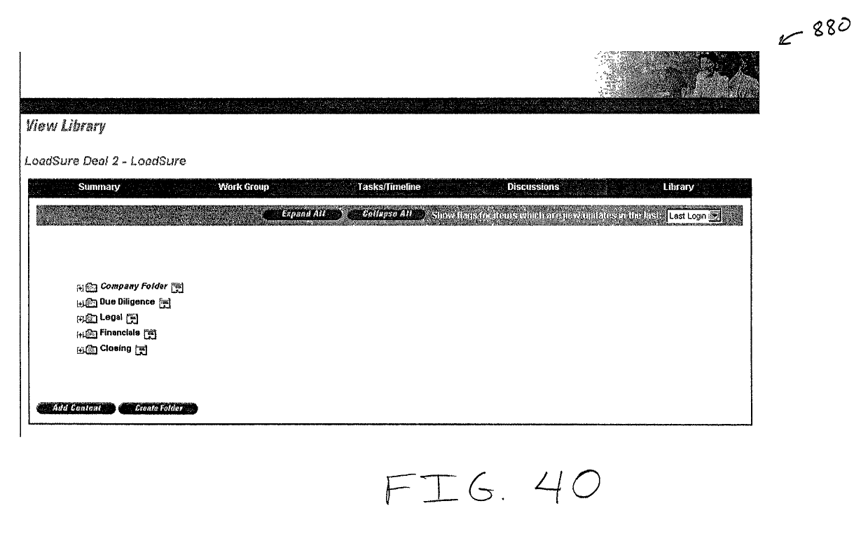

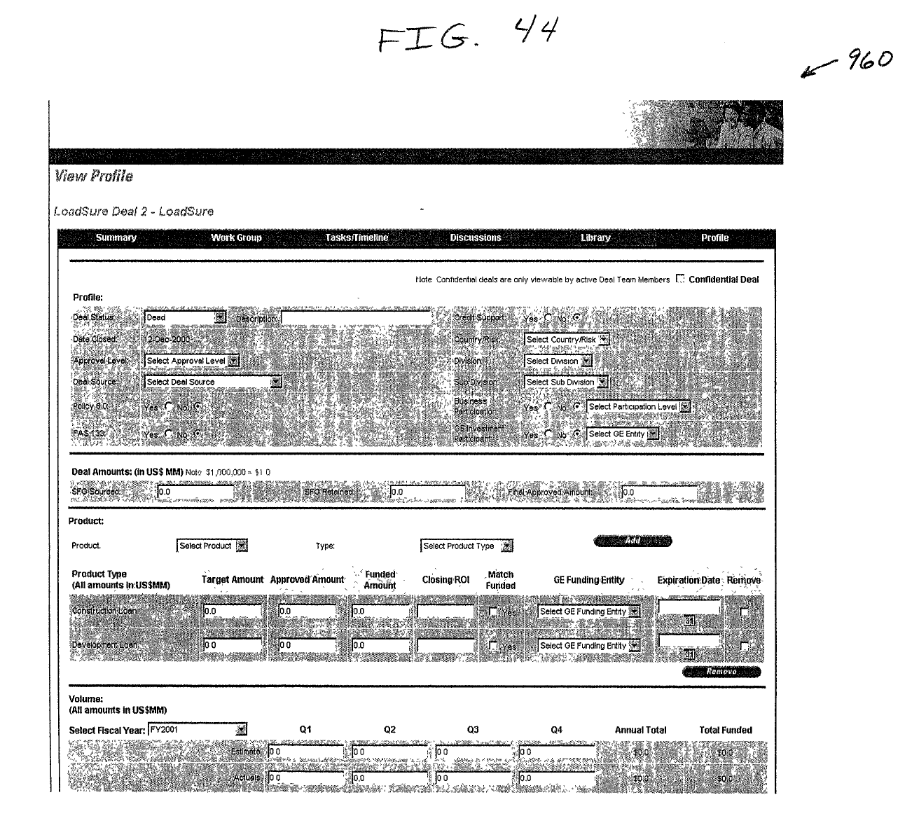

Set forth below are details regarding exemplary hardware architectures (FIGS. 2 and 3), an exemplary process diagram illustrating various system capabilities (FIG. 4), exemplary screen shots displayed by the exemplary system to a user desiring to set up a profile for one of a number of business using the system (FIGS. 5-8), exemplary screen shots displayed for facilitating preparation of templates for libraries and tasks (FIGS. 9-13), exemplary screen shots displayed for deal creation and summarization (FIGS. 14-16), exemplary screen shots displayed for set up of workgroups, companies, team members and their profiles (FIGS. 17-25), exemplary screen shots displayed for creating, modifying, assigning and notification of tasks and milestones (FIGS. 26-34), exemplary screen shots displayed for facilitating discussions and customer feedback (FIGS. 35-39), exemplary screen shots displayed for preparation and maintenance of libraries (FIGS. 40-43), and exemplary screen shots containing deal profiles and search capabilities (FIGS. 44-47).

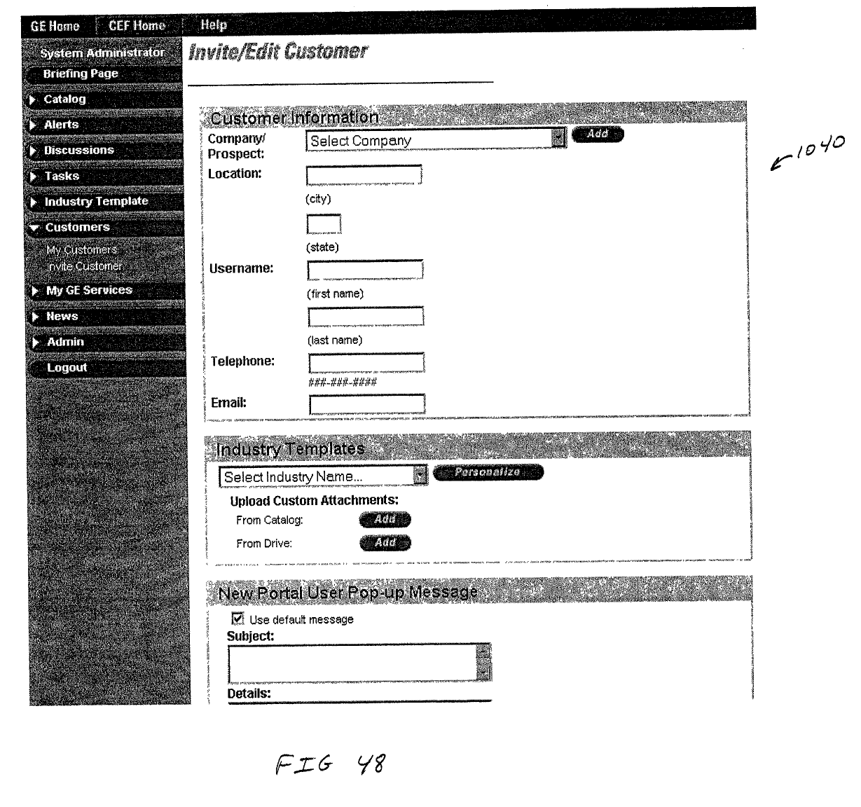

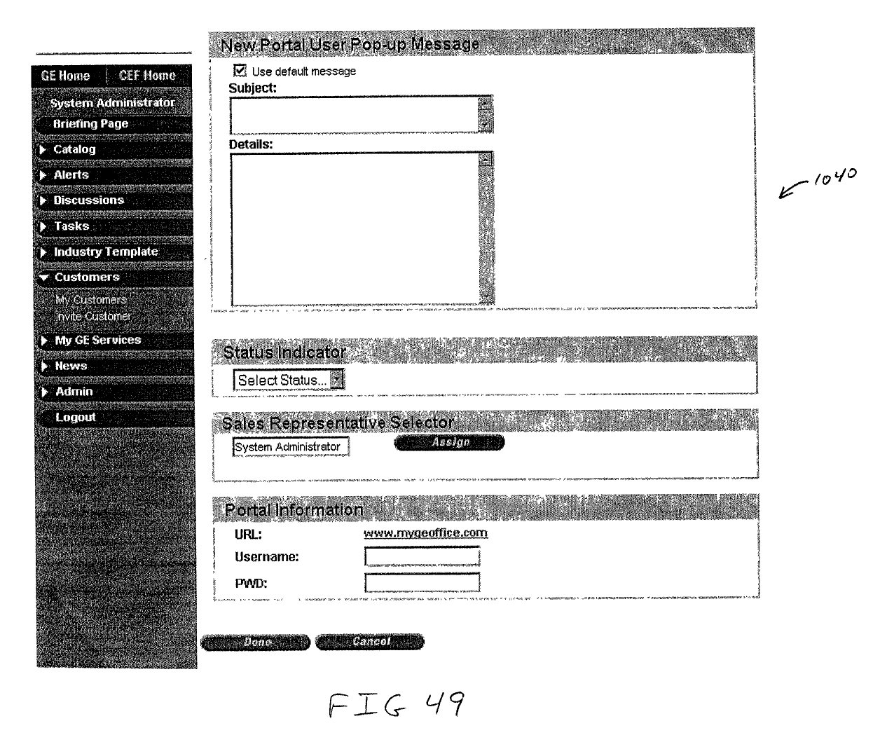

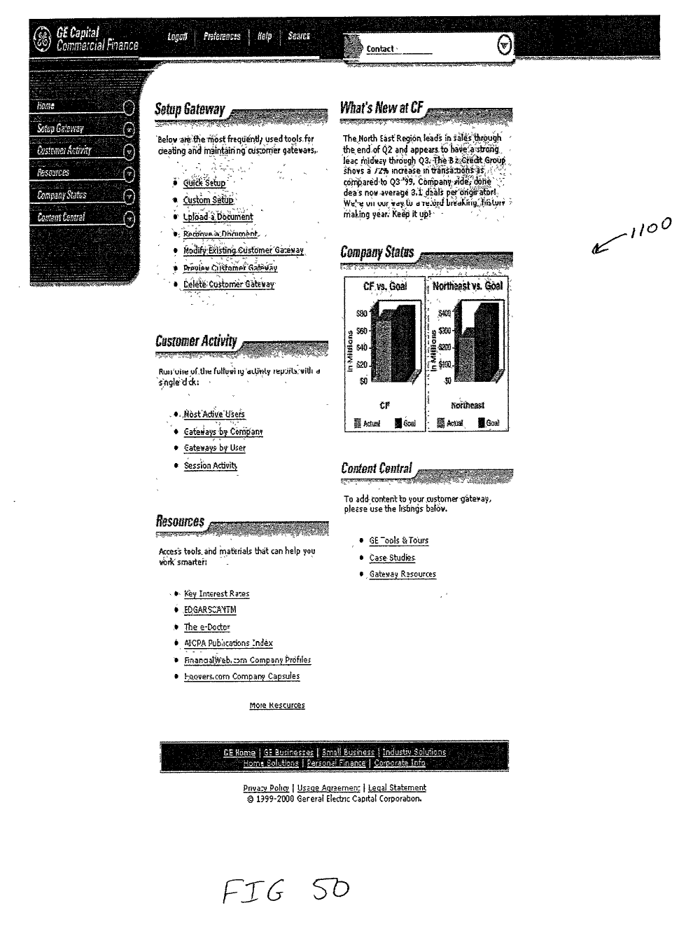

Exemplary screen shots for prospect and customer contact include personal portal interface web pages (FIGS. 48-49) and prospect web pages (FIGS. 50-55) for facilitating prospect contact. Although specific exemplary embodiments of methods and systems for facilitating prospect contact and tracking of deals are described herein, the methods and systems are not limited to such specific exemplary embodiments.

Hardware Architecture

FIG. 2 is a block diagram of a system 100 that includes a server sub-system 102, sometimes referred to herein as server 102, and a plurality of customer devices 104 connected to server 102. In one embodiment, devices 104 are computers including a web browser, and server 102 is accessible to devices 104 via a network such as an intranet or a wide area network such as the Internet. In an alternative embodiment, devices 104 are servers for a network of customer devices.

Devices 104 are interconnected to the network, such as a local area network (LAN) or a wide area network (WAN), through many interfaces including dial-in-connections, cable modems and high-speed lines. Alternatively, devices 104 are any device capable of interconnecting to a network including a web-based phone or other web-based connectable equipment. Server 102 includes a database server 106 connected to a centralized database 108. In one embodiment, centralized database 108 is stored on database server 106 and is accessed by potential customers at one of customer devices 104 by logging onto server sub-system 102 through one of customer devices 104. In an alternative embodiment centralized database 108 is stored remotely from server 102.

FIG. 3 is a block diagram of a network based system 122. System 122 includes server sub-system 102 and customer devices 104. Server sub-system 102 includes database server 106, an application server 124, a web server 126, a fax server 128, a directory server 130, and a mail server 132. A disk storage unit 134 is coupled to database server 106 and directory server 130. Servers 106, 124, 126, 128, 130, and 132 are coupled in a local area network (LAN) 136. In addition, a system administrator work station 138, a work station 140, and a supervisor work station 142 are coupled to LAN 136. Alternatively, work stations 138, 140, and 142 are coupled to LAN 136 via an Internet link or are connected through an intranet.

Each work station 138, 140, and 142 is a personal computer including a web browser. Although the functions performed at the work stations typically are illustrated as being performed at respective work stations 138, 140, and 142, such functions can be performed at one of many personal computers coupled to LAN 136. Work stations 138, 140, and 142 are illustrated as being associated with separate functions only to facilitate an understanding of the different types of functions that can be performed by individuals having access to LAN 136.

Server sub-system 102 is configured to be communicatively coupled to various individuals or employees 144 and to third parties, e.g., customer, 146 via an ISP Internet connection 148. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 150, local area network 136 could be used in place of WAN 150.

In the exemplary embodiment, any employee 144 or customer 146 having a work station 152 can access server sub-system 102. One of customer devices 104 includes a work station 154 located at a remote location. Work stations 152 and 154 are personal computers including a web browser. Also, work stations 152 and 154 are configured to communicate with server sub-system 102. Furthermore, fax server 128 communicates with employees 144 and customers 146 located outside the business entity and any of the remotely located customer systems, including a customer system 156 via a telephone link. Fax server 128 is configured to communicate with other work stations 138, 140, and 142 as well.

FIG. 4 is a high level diagram 170 depicting a deal process through functionality of system 10. In one exemplary embodiment, deal prospects access 172 system 10 through web pages configured to communicate potential deal solutions to those prospects. In another exemplary embodiment, identified prospects are able to access 174 system 10 via a customized portal, specifically configured to attract that particular prospect to deal solutions. Once a prospect is interested in deal—making, regardless of the initial interface used, deal creation, processing and managing follow a common process, which the prospect turned customer is included in as part of a deal team.

In one exemplary embodiment, business profiles 176 are a grouping of screens which are populated by an administrator, and provide for internal and external user a path to a particular business or division for possible deal making. Tools used in creating a deal 182 include library templates 184 and task and milestone templates 186. Library templates 184 provide suggested groupings of folders and sub-folders for storage of documents relating to a deal. Templates 186 provide suggested groupings of milestones, and the tasks and sub-tasks needed to complete each milestone. Taken together, the milestones and tasks identified and populated using templates 186 provide a deal timeline. Templates 184 and 186 are described in greater detail below. User input into system 10 causes system 10 to create and save a deal. Creation of a deal within system 10 starts other system activity, including creation of a number of deal specific forms and screens (described below in detail), some of which are populated from further user input, others are automatically populated by system 10 using deal information, common to all deals, provided by the stored templates for the business and further providing a search functionality and a report generation capability.

Deal summary 188 is in one embodiment, a screen (described below) which include all pertinent, deal specific information in a snapshot overview. The overview contains at least one of a deal name, a customer company name, a deal summary timeline, a summary of deal activity and contact information for key deal team members.

Deals are created using a create deal function, which is, in one embodiment, accessible from any screen. Selecting the create deal function presents to the user a screen which is configured to allow a user to create a workspace for a new deal. A series of screens, through which a deal is created, captures information about the deal that will be displayed in the workspace for the deal.

One exemplary screen, a briefing page, described below, provides a listing of all deals (with key summary information) that a user has permission to view and is the first screen presented to a user, who is a member of at least one active deal team, after a successful login. A user is able, in one embodiment, to access the briefing page from any screen.

Deal workgroup 190 is a grouping of screens (described below) which shows information about companies and employees involved in a deal. Any user added to the workgroup can be involved with notifications, discussions and content items added to the deal. In one embodiment, companies are listed in the workgroup with deal team members listed below each company the team member is associated with. Companies and users that are involved in the deal are added through a deal team page, described below. Information captured about a company that is part of the deal team includes the company's role in the deal, the primary contact for the company and may include the team designation for the company (internal or external). Information captured about a user that is part of the deal team includes the role of the user in the deal.

Deal timeline 192 is a grouping of screens (described below) which contain milestones and tasks for current deals. The milestones, tasks and sub-tasks that belong to each milestone are added to the deal timeline based on the default task template assigned to the current deal. Additionally, system 10 allows a deal team member to input customer request dates and add ad-hoc tasks to the deal when necessary. Information displayed includes the milestones for the current deal, current due dates and actual completion of each milestone, and tasks and sub-tasks required to complete each milestone through assignment and management of the tasks.

Deal discussions 194 are a grouping of screens (described below) whose functionality provides for the exchange of ideas and concerns among deal team members and in one embodiment includes a voice of the customer feedback screen grouping.

Deal library 196 is a grouping of screens through which a content repository for the current deal is obtained. A folder structure for the current deal is based on the default library template assigned to the current deal providing the ability for deal members to categorize and store content (i.e. documents) related to the deal. Content added to library 196 can have attributes assigned to give only specified users or groups permission to access the item. Users with proper attributes can browse deals within the library and all relevant content. Documents within the library can be viewed along with meta-data about the document stored in an “index card”. The “index card” is a further grouping of screens (described below) which provide functionality to access and search libraries. Two levels of security exist in one particular embodiment, folder permissions and document permissions.

Deal profile 198 is a grouping of screens through which information about a deal is captured, including, but not limited to, profile, product, volume, and dollar amounts giving deal team members further insight into the particulars of a deal, deal profiles are customizable for individual companies.

Exemplary Viewable Screen Shots

To implement the above described system, many variations of particular viewable screens can be utilized. The following screen descriptions refers to one set of screens that can be used for prompting necessary inputs for deal creation and maintenance and review of deal data stored within system 10. Variations of such screens are possible.

Create/Modify Business Profile

FIG. 5 is an exemplary screen shot of an electronic business profile form 200, located within database 18 of system 10. Business profile form 200 is one screen, displayed to an administrator user, allowing definition of feature lists, deal visibility rules, and header graphics for the administrator's business unit. In one embodiment, only one business profile form 200 is allowed for each business, however the business administrator has the ability to set up and maintain their own business's structure. The business's name of the login administrator will be displayed below a form title. In one embodiment, only one header graphic is allowed for each division, and the default division header is the header for the business that the division is in. The administrator has the option to select any of the check boxes to turn features “on and off” for each business and can define the divisions and sub-division within each business. System 10 does not limit the number of divisions and sub-divisions that can be created. Each authority level is set at both the business and division level and permission at a division level over-rides permission given at the business level. In one embodiment, each business, division and sub-division level has three authority levels: User, Manager and Administrator. The administrator is required to define the deal permissions for each authority level. (i.e. who can Create a Deal)

Included in business profile form 200 are a name of the business, which defaults to the business's name for the login administrator, a go to Market Name which is a name that the business will display on customer facing screens, header graphics for the business, which is in one embodiment, an image file. A Document Search check box is configured to be selected by the administrator if the users in the business are to have access to Document Search capability. If selected, users within the business unit are able to select menu items that are defined to search the documents.

A User Alerts check box, if selected, indicates that the users in the business have access to Person-to-Person Alerts and therefore allows business members to communicate via person-to-person alerts within individual deal rooms.

A Deal Search check box, if selected, indicates that the users in the business have access to Deal Search capability and users are able to click on menu items that are defined to search the deals. A Customer Shared Space check box, if selected, indicates that the users in the business have access to the Customer Shared Space and any functionality within the shared space. A Deal Group check box, if selected, indicates that the users in the business have access to use Deal Group capability and place deal members in the user groups.

Information Visibility (Division/Sub-Division) in one embodiment, are selection options where an administrator is able to configure system 10 to control what information users in the business can see. Selecting across business allows a user to see information across the business, as opposed to only the division or sub-division the user belongs to. Deal Visibility permissions are assigned and associated to the three default authority levels (User, Manager, Admin) and if they can view/ Modify active deals and/or view Closed/Lost deals.

In one embodiment, system administrators have the option to grant permissions associated to some features for each user authority level. Permission which may be granted include, but are not limited to, permission to create new deals. Timeline Task Template Create/ Modify which, if selected is an ability to create new or modify existing timeline task templates, Task Template View which is permission to view all timeline task templates across all divisions within the business and Task Template Delete which is permission to delete timeline task templates across all divisions within the business.

In another embodiment, system administrators have the option to define permissions for library templates Create/ Modify, if selected, is a permission to create new or modify existing library templates. Library Template View, if selected, is a permission to view all library templates across all divisions within the business and Library Template Delete, if selected, is a permission to delete existing library templates.

In still another embodiment, system administrators have the option to define permissions for searches of deals and documents. If selected by an administrator, a user may to search all deals within the business and all documents within the business that the user has permission to view.

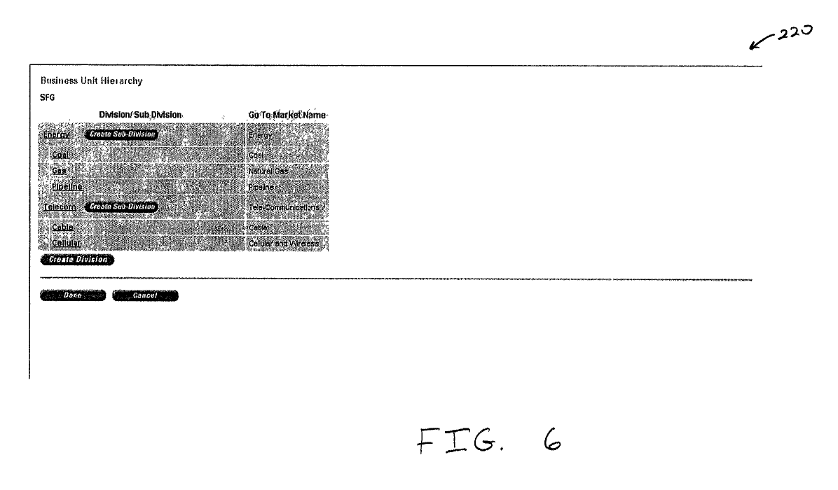

FIG. 6 is a hierarchy list on a business hierarchy screen 220, displayed to an administrator user, which defines corporate structure for the business. In one embodiment, the list is structured upon an administrator's first and subsequent configurations. An administrator can create new divisions and sub-divisions and modify existing divisions and sub-divisions in the list. The business's name of the login administrator is displayed above the hierarchy list. In one embodiment, rules followed include that a sub-division can be created within only one division, there is no limit with the number of divisions and sub-divisions that can be created for each business and Division and Sub-Divisions cannot be removed once they are created.

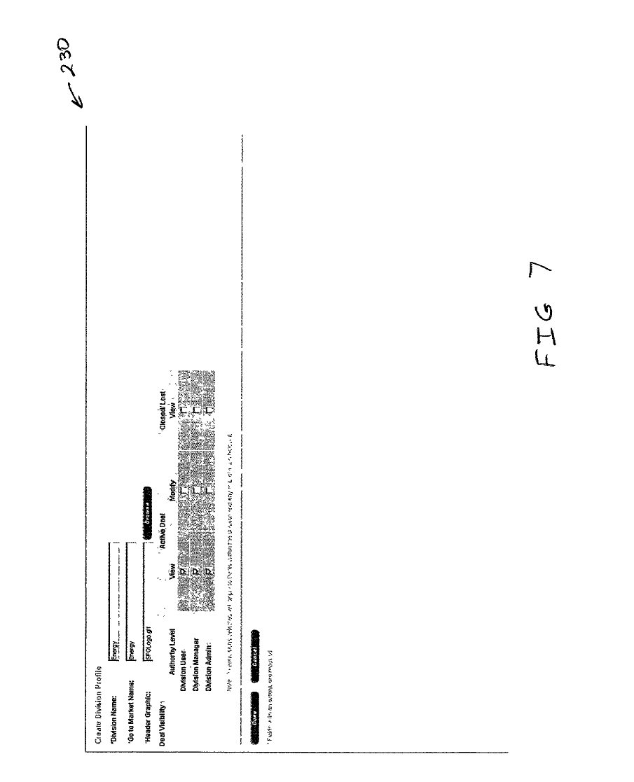

FIG. 7 is a create division profile screen 230 which is displayed when a user selects to create a business division (shown in FIG. 6). Division profile screen 230 is used to capture detailed information of the selected division within the business as input by a user, including a name which is unique within the business. Header graphics are inherited from the business, but can be changed and in one embodiment, only one header graphic is allowed for each division. Permissions set on this page can be set at the division level and sub-division level.

Included in screen 230 is a Division Name, which is unique within the business, a Go to Market Name for the division, which defaults to the business name unless otherwise indicated, a Header Graphic inherited from the business and deal visibility levels which define deal visibility permissions associated to three authority levels (i.e. Admin, User, Manager) created for the new division. The administrator defines the deal visibility permissions associated to the three business levels created for the new division. Each business group within the division uses the division name once the administrator enters the name.

A Modify Division Profile screen (not shown) is used by the Administrator to modify the detail information of the selected division within the business.

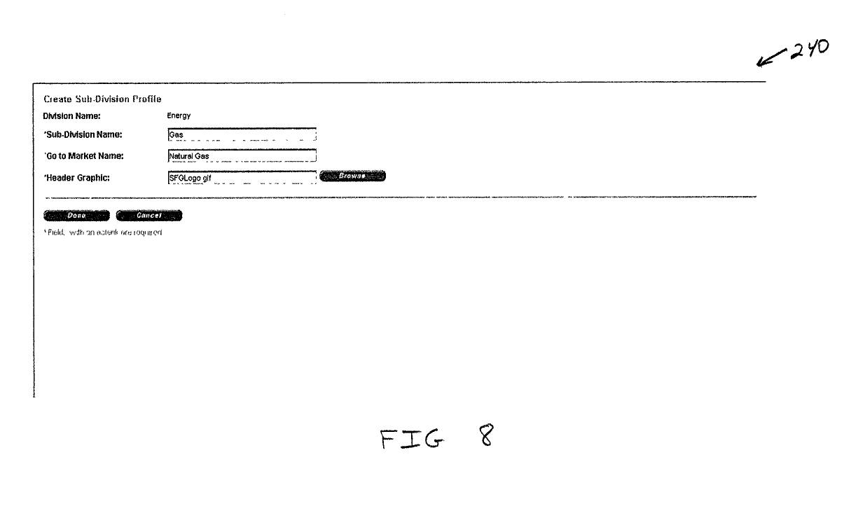

FIG. 8 is a create sub-division profile screen 240 which is displayed when a user selects to create a business sub-division. Create sub-division profile screen 240 allows a capture of detailed information of the selected sub-division within the business. A division name is displayed which is based on the division selected on Business Hierarchy form 220. A sub-division name is unique within a division and header graphics are inherited from the division upon creation, but can be changed. Only one header graphic is allowed for each sub-division. A Go to Market Name for the sub-division defaults to the division name otherwise changed.

A Modify Sub-Division Profile screen (not shown) is used by the Administrator to modify the detail information of the selected sub-division within the business.

Library Templates

FIG. 9 shows an exemplary embodiment of a Library Template screen 260. Library templates are configured to enable businesses to create customized library folder structures to be associated with a deal at the time of creation. Library Templates promote consistency across deals and save a considerable amount of effort to setup a folder structure. In one embodiment, users have at least View Library Template permission to access screen 260. Again referring to screen 260, the Library Templates screen 260 is configured to allow the user to view all Library Templates for the business. The user can also see other summary information such as who created or modified a template and when. Finally, users with permission can opt to remove a template, create a new one, or select the default template for each division. In one embodiment, Library templates default to the division level, therefore a default template for each division is created, which are not seen across businesses. Users can have one of view or modify template permission.

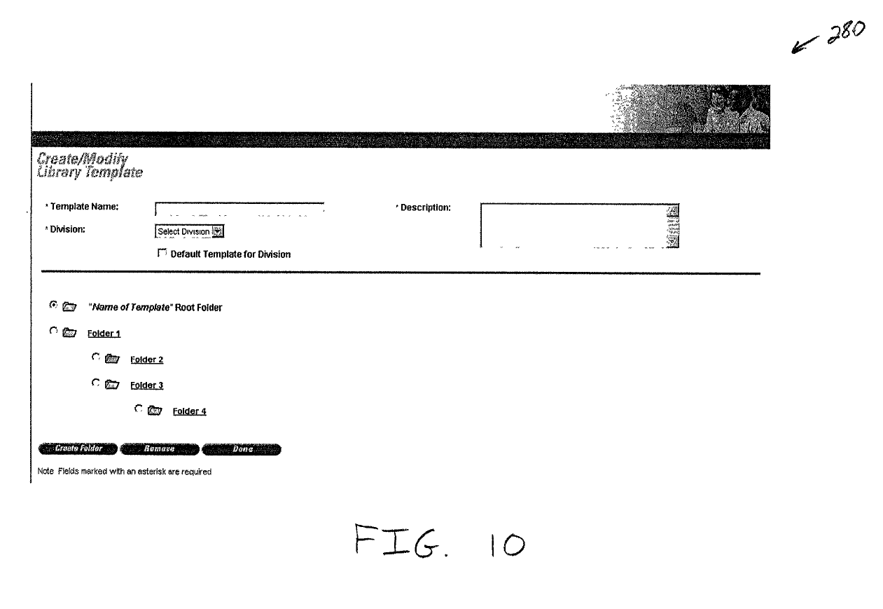

FIG. 10 is an exemplary example of a Create/Modify Library Template screen 280. Screen 280 is configured to capture information for a library template. Users provide summary template information to define the template attributes before defining the actual folder structure for the template. Library Template names are unique within each division and in one embodiment, only users with Modify Library Template permission may modify screen 280, which is done by selecting a parent folder on screen 280 for the new folder the user is creating. Removal of a folder will cause removal of all of its sub-folders.

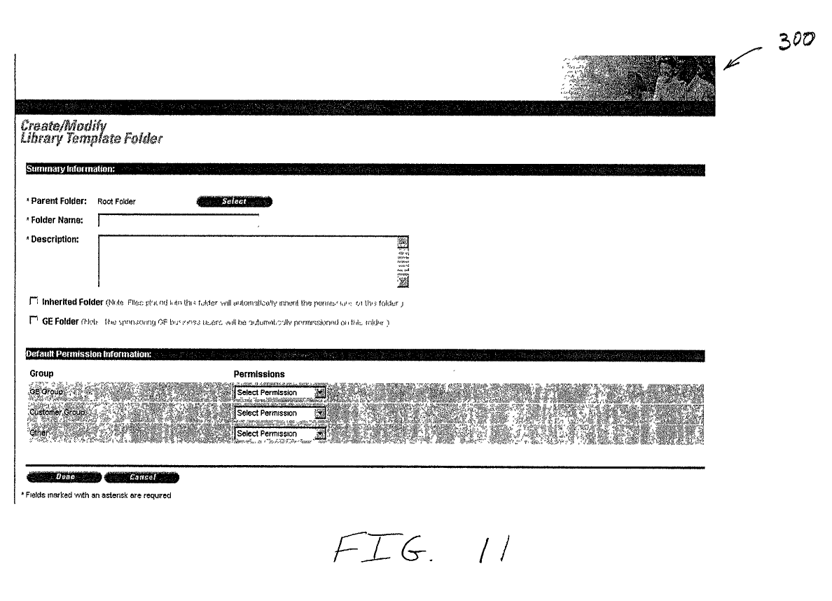

FIG. 11 is a Create/Modify Library Template Folder screen 300. Screen 300 is configured to allow a user with proper permissions to define or modify a template folder's attributes and permission groups on the template folder. For example, in one embodiment, a folder can only have one parent folder and if a folder is marked as an Inherited Folder, all files placed in this folder will inherit the permissions of the folder. In another embodiment, if a folder is marked as a company Folder, the sponsoring company business users automatically have permission to access the folder. A Parent folder name is automatically defined from the previous Create/Modify Library Template. Default Permission Information is visible if “Deal Groups” is selected in the Business Profile (described above in FIG. 5).

Task Templates

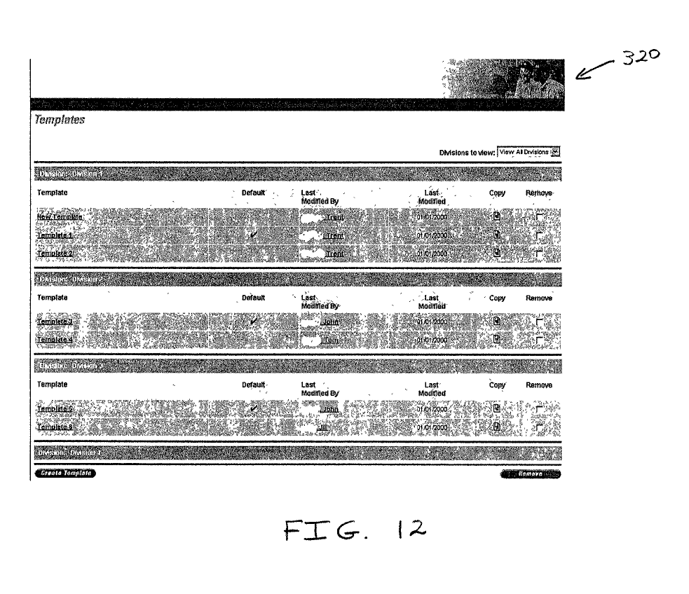

A Task Templates application allows businesses to define templates comprised of milestones, tasks and sub-tasks to be used throughout the deal process thereby allowing a consistent approach to deals and helping team members monitor the progress of the deal. Default templates are defined for each business, division or sub-division allowing appropriate templates for each deal, typically the first template created. FIG. 12 is an exemplary view templates screen 320 which displays a list of the templates that are available to the current user. View Templates screen 320 is configured to display a list of the templates that are available to the current user. If a user has modify permission, they may create a template from scratch or base it on a single existing template. A user with delete permissions will also be able to remove templates from the listing. A user with View permission will only be able to view details about the given templates. Users outside of the company are not, in one embodiment, able to access screen 320.

Templates are displayed either across the business (i.e. for every division) or for a single division or sub-division depending upon the configuration of the Business Profile (shown in FIG. 5). In one embodiment, once a template is modified or removed there is no undo feature although the user is sent a message to verify that the user is changing the default template. Sorting of the template defaults, in one embodiment, is alphabetical by division and then by template name. Also included is the name of the user who last modified the template and the date the template was modified. Documents that are associated at the task template level are downloaded, modified, and uploaded to a Deal Library.

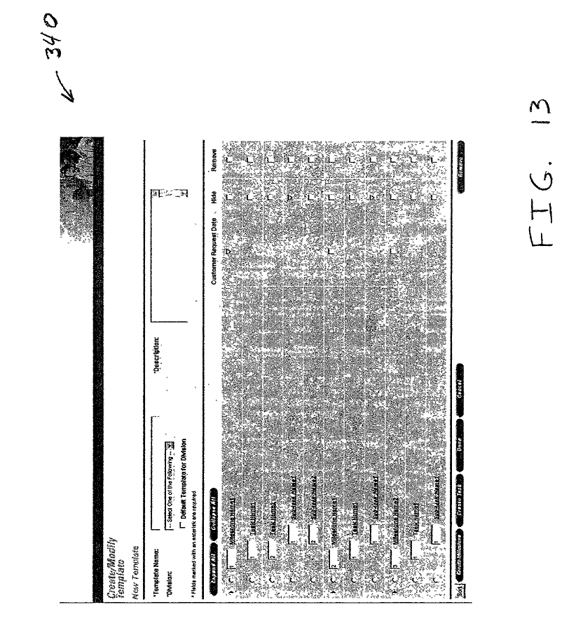

FIG. 13 is a Create/Modify Template screen 340 where users are allowed to add milestones, tasks, and sub-tasks to a template and to set the appropriate properties, including whether or not a task/sub-task is hidden or omitted, and type of task. All milestones/tasks/subtasks are visible to all company users and those users have the ability to hide milestones/tasks/sub-tasks from the customer. In one embodiment, only users with modify permissions can create/modify milestones/tasks/subtasks which may be ordered. Tasks are associated with milestones and sub-tasks are associated with a task. Documents associated to tasks in the template reside in a Resource Center (not shown). Screen 340 includes a Create Milestone button used to add a milestone to the template and a Create Task button used to add a task to the template.

Deal Creation

A deal management section includes functionality that is available only to those team members who have the ability to create and modify a deal. FIG. 14 is an exemplary embodiment of a create deal screen 360 used by users, with proper permission attributes, to create new deals. To create a deal users are able to select a Library Template when creating a deal but, in one embodiment, cannot change or combine Library Templates within a deal. In another embodiment, users are able to select a Task Template when creating a deal but are not able to change or combine Task Templates within a deal.

Screen 360 includes a field which displays all the letters of the alphabet which is used to quickly populate a Company Name selector box. Further included is a textbox for the string that will be used either in a sub-string search or a prefix search, a list box populated with companies, and an input box for deal name. Selection of a create button causes system 10 to create a new deal using the selected timeline and library templates, causing creation of deal screens as further described below.

Deal Summaries

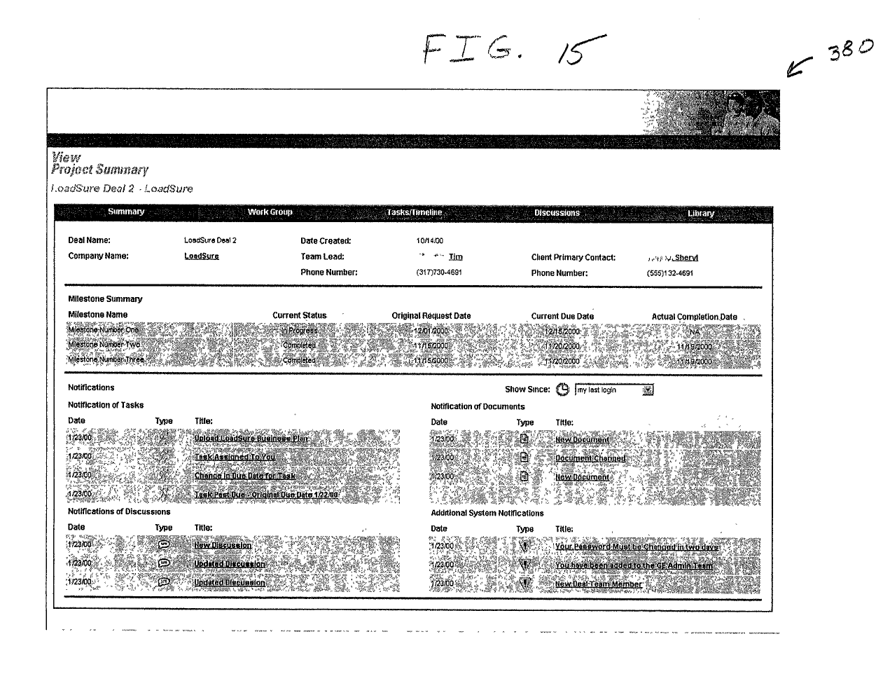

FIG. 15 is an exemplary embodiment of a Deal Summary screen 380. Deal summary screen 380 displays three different sections of deal information to allow the user to quickly determine status of a deal. The first section provides general information on the deal including creation date and contact information as well as the deal status. The second section provides a listing of milestones not hidden from external view and the associated dates including current status, customer original request date, current due date, and actual completion date. The last section provides a summary of all notifications tied to the time horizon including a task notification which occurs when a task is initially assigned to a user, reassigned to a user, due date is changed, notices of upcoming due date, and past due notices. Also included in the summary section are document notifications which occurs when a new document that a user has permission to access is added, a document that the user has been subscribed to changes, and a document that a modifier specifically selects to notify the user of the change. Further, a discussion notification occurs when a new discussion is created or a discussion that the user has subscribed to is changed and also system generated notices which includes new team members, new group permission, and changes to permission notices.

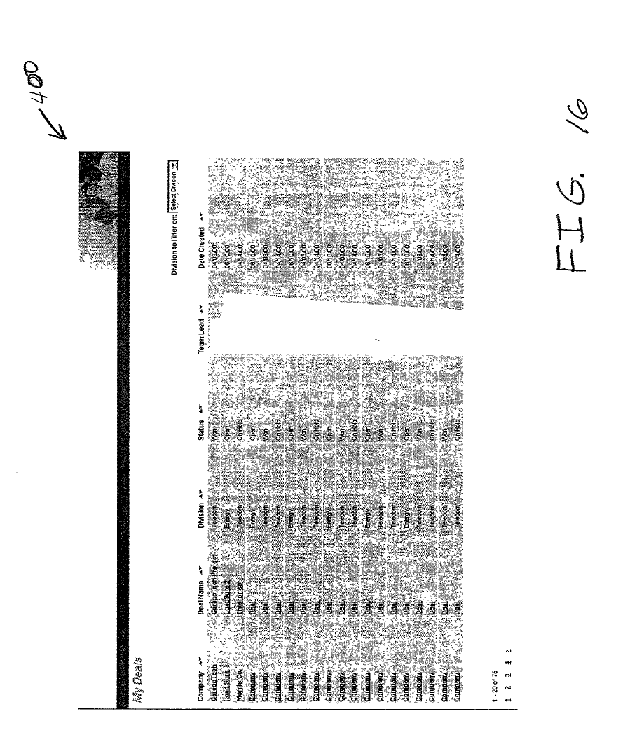

FIG. 16 is a deal list screen 400 configured to allow a user to access a complete listing of the deals that they have permission to view. In the embodiment shown, a listing includes company names, deal names, divisions, deal status, a team leader and a deal creation date. From screen 400 the user is able to select a deal and view a deal summary (described in FIG. 15) and drill-down for additional details. Alternatively, the user can select a company and further select from deals for the selected company for the additional details.

Deal Workgroup

FIG. 17 is an exemplary work group screen 420. Screen 420 is configured to allow the user to select, view and manage the companies and users involved with a specific deal. Companies and their users, and roles for each user can be added to the deal through screen 420, along with identifying a primary contact for the company. User can also be removed from the workgroup by selecting a remove checkbox for the user. Electronic mail can be sent to one or more users, in one embodiment, by selecting a displayed E-mail address on screen 420. Any user added to the work group can be involved with notifications, discussions and other deal items. In one embodiment, companies are listed on screen 420 with their deal team members listed below. Screen 420 provides a business with an ability to maintain information on customers and third party members within the deal and track immediate roles of people throughout the deal process. In one exemplary embodiment, company roles for the deal may include, but are not limited to, advisor, agent bank, appraiser, arranger, broker, charterer, consultant, contractor, developer, equity investor, fuel supplier, general partner, guarantor, intermediary, issuer, legal counsel, limited partner, off-taker, operator/manager, other businesses, senior lender, sponsor, steam host, syndication agent, utility, vendor, capital markets, equity external counsel, intermediaries/agent, co-investors, co-investor's legal counsel, company, company's legal counsel, and other consultants.

User roles within one exemplary embodiment include, but are not limited to, capital markets, environmental, finance, insurance, leasing support, legal, origination, lead originator, portfolio, support, technical, underwriting, lead underwriter, MD, deal manager, team member, research, legal, risk, finance and accounting, tax, quality—strategic partnership, quality—operations consultant and investment committee.

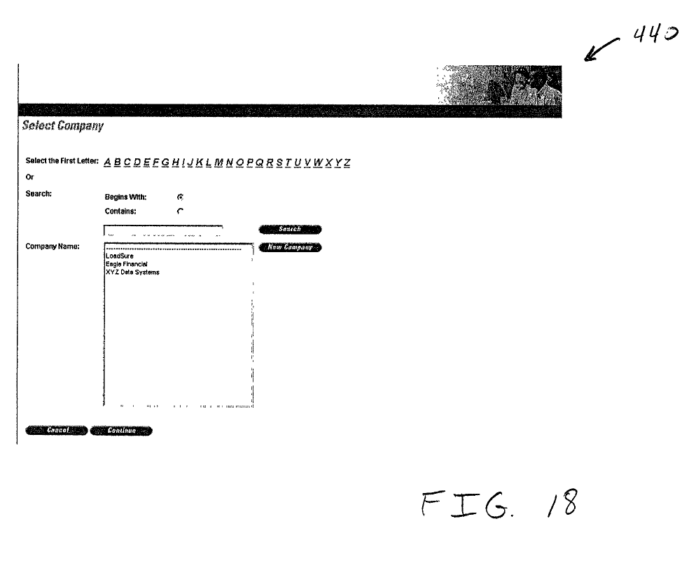

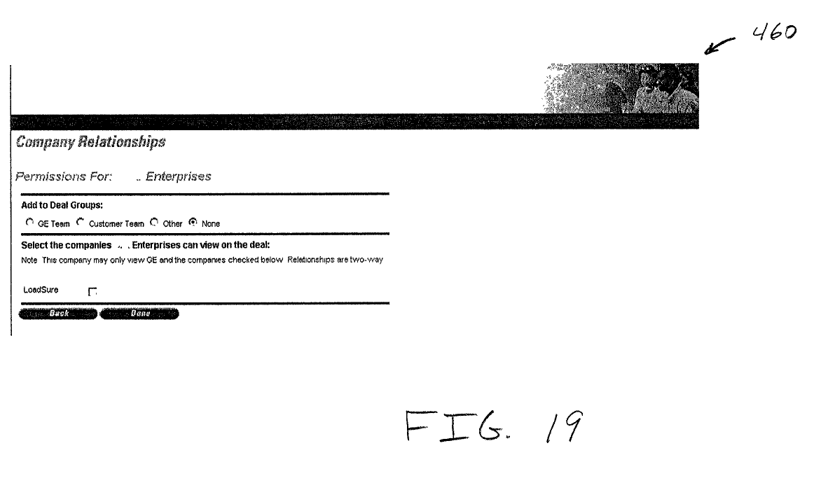

FIG. 18 is an example of a select company screen 440. Select Company screen 440 lists the companies a user can add to a deal, as described in FIG. 17 above. Only one company may be added at a time. If a company is not listed in the list box, a user may create a new company profile by navigating to the Create Company page. Upon selection of a company, and in one embodiment, the user is automatically directed to a company relationships page (described in FIG. 19). Only users with Modify Deal permissions are able to access screen 440 and only users with Create Company permissions have the New Company button appear. In one embodiment, screen 440 displays all the letters of the alphabet that will be used to quickly populate the Company Name selector Box.

A Company Relationships screen 460 is shown in FIG. 19. Company Relationships screen 460 allows an authorized user to give permissions to new companies in relation to other companies on a deal. In one embodiment, the user can select whether or not the new company will be able to see the other companies within the deal workgroup. A selected box on screen 460 indicates both companies will be able to see each other in the deal. The user can also select a workgroup to place the company into thereby setting a permission level on all deal items equivalent to that of the selected group. In one embodiment, only company team members are able to access screen 460.

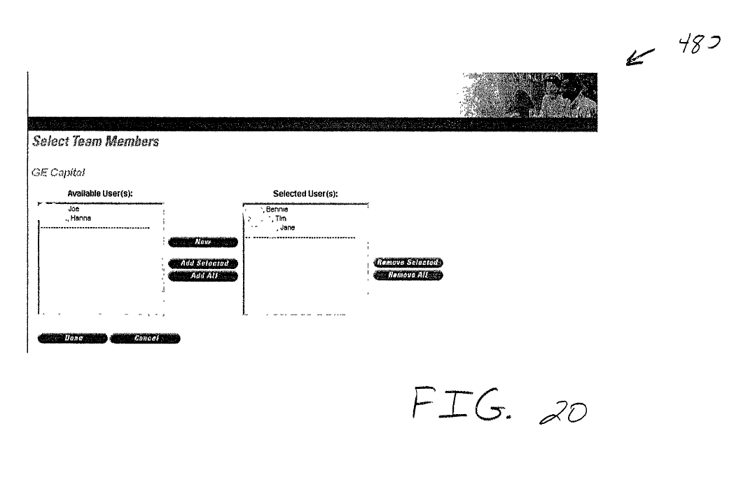

FIG. 20 is a Select Team Members screen 480 which facilitates adding new users to a deal team. A New button is displayed, in one embodiment, for users who have permission levels to create new users for a specified company. Names appearing in the Selected box when the Done button is selected will be added to the deal. Screen 480 is also configured to facilitate deletion of team members.

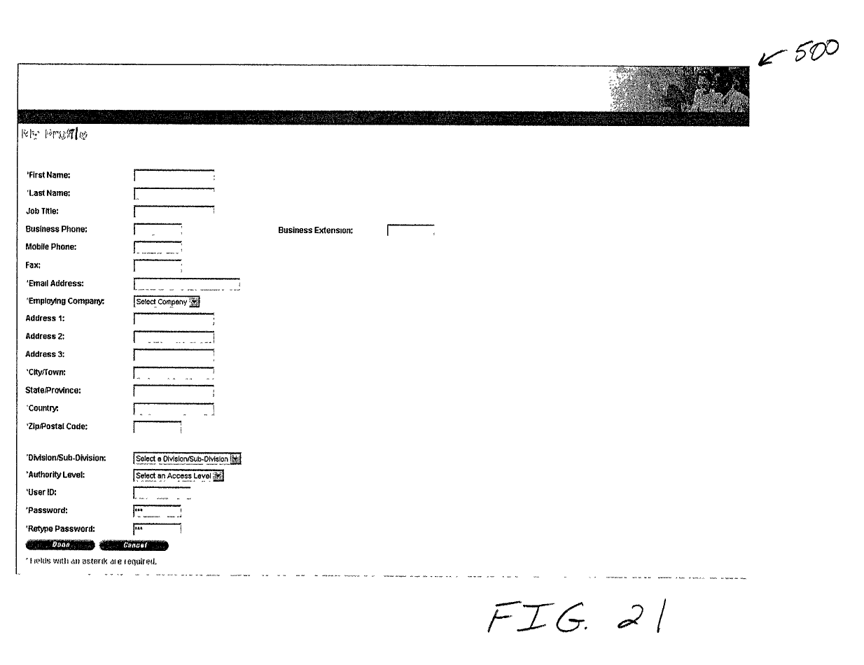

Selection of team members for a deal necessitates knowledge of the possible team members. FIG. 21 is one embodiment of a My Profile screen 500 which is available to all users, and provides information on the individual profiled. Screen 500 allows all users to update existing profile information and other administration details, for example, changing passwords. Managers and administrators at different levels (division, sub-division) are contemplated.

Fields included within the embodiment of My Profile screen 500 shown in FIG. 21 include the User's first name, last name, job title, business phone number and extension if applicable, a cell phone number, a fax number, an email address and an employing company. Further included are multiple address fields, a user authority level, a Division/Sub-Division, user defined system identification, a user defined system password, and a field to validate password.

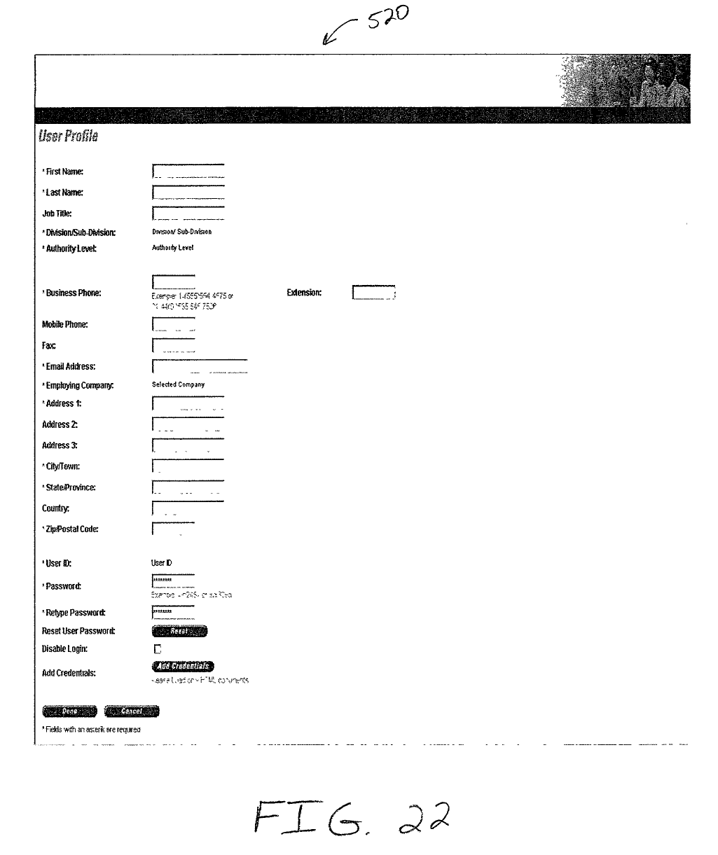

FIG. 22 is an embodiment of a user profiles screen 520, which is available to users that have Modify User Profile permission. Screen 520 allows a user to add new users to a company including each of the company businesses and edit all existing users for companies that the user has permission to see. A check box is included to disable user logins, and a users password may be reset from screen 520. The other fields are the same as in my profiles screen 500, shown in FIG. 21. Users in external companies are only able to add users to their company space.

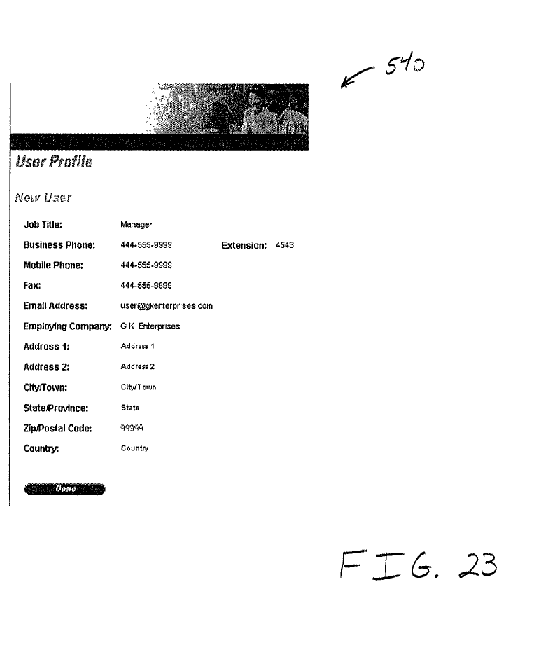

FIG. 23 is a user profile pop-up window 540 which shows a deal member's user information. The user information displayed is that described above when adding users to a deal within system 10. When a deal member's name is selected, window 540 is displayed in front of the existing deal workspace, so that user information can be accessed exclusive of the deal pages. Window 540 cannot be edited, in the embodiment shown.

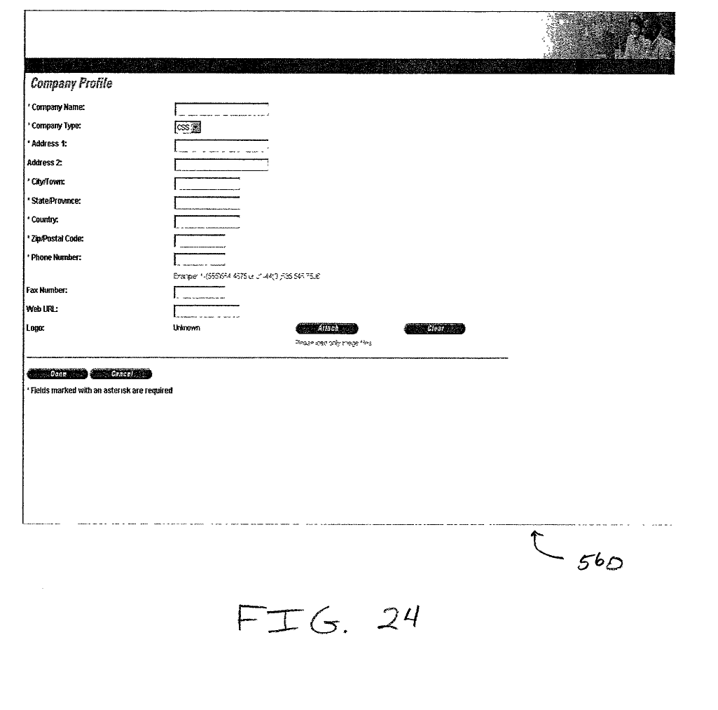

A Company Profiles screen 560, shown in FIG. 24 is only available to users that have Create/ Modify Company Profile permission. Screen 560 allows a user to edit profile information for current companies and add new companies and is accessible from both Create Deal screen 360 (shown in FIG. 14), via the Create New Company button or from a Company Selector screen (not shown). Only company users are able to navigate to screen 560 to create and modify company profiles. Any company records are grouped with the Business and Division for which they are created.

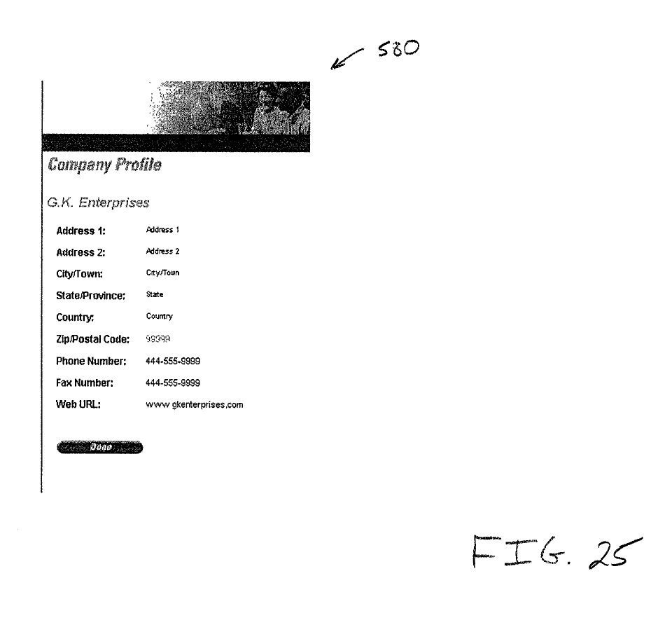

FIG. 25 is a Company Profile Pop-Up window 580 which shows company contact information, for example, address, telephone and E-mail for a company in a deal workgroup. When a company's name is selected, window 580 is displayed in front of the existing deal workspace, so that company information can be accessed exclusive of the deal pages.

Deal Timeline

FIG. 26 is an example of a Briefing Page 600 which contains a channel that provides summary information from multiple applications organized in focused pieces, including a deal dashboard. The Deal Dashboard displays high-level deal information for all active deals that the user is an active deal participant on. The information displayed as part of the dashboard is intended to provide a deal participant with a quick overview of deal status and activity. The channel includes high-level summary information for each deal. In the embodiment shown, the defaults are last milestone with completion date, next milestone with scheduled completion date, team lead with phone number, customer lead with phone number, deal size, deal status, your number of outstanding tasks, and new notification summary (including icons). Milestones displayed on briefing page 600 are noted on a task template. Milestones that are hidden on the task template will not appear for users outside of the company.

Included on briefing page 600 is a Time Horizon which allows a user to decide which time horizon to use to display task notifications. In one embodiment, time horizon is defaulted to the time horizon of the last user login. In another embodiment, values for the time horizon are one, seven, fourteen, thirty days, and All. An expand all button expands all deals in the channel. A collapse all button collapses all deals in the channel. An expand/collapse arrow expands or collapses detail information for a particular deal.

Further included on briefing page 600 is Company/Deal Name which indicates the names of the company and the deal. A user must be an active member on the deal team to have a deal appear on their briefing page. Selecting the primary contact link allows a user on the deal team to view the company Team Lead, whose name is a hyperlink to the lead's profile and their telephone number. Further included is a customer lead whose name is a hyperlink to the lead's profile list and their telephone number. Regarding the deal included on briefing page 600 is a deal size including a currency value that represents how much the deal is worth, and outstanding tasks of the user, which is a total of all outstanding tasks as of that day, not marked as completed that has been assigned to the user.

A Task Icon on page 600 is a link to a deal summary screen (described in FIG. 15). Numbers in parenthesis are a total of all new tasks assigned or changed that the user is associated with and is tied to the time horizon. A Document Icon is also a link to the deal summary screen. The number in parenthesis is a total of all new documents assigned or changed that the user is subscribed to and is tied to the time horizon. A Discussion Icon is also a link to the deal summary screen. The number in parenthesis is a total of all new discussions assigned or changed that the user is subscribed to and is tied to the time horizon. An alert notification icon is also linked to the deal summary screen. The number in parenthesis is a total of all new system-generated notifications that the user is associated with and is tied to the time horizon and includes all new user-to-user alerts that the user is associated with and is tied to the time horizon.

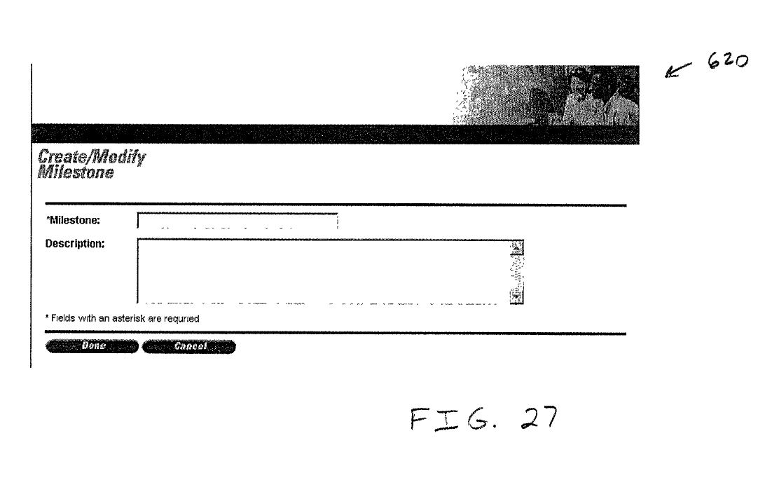

FIG. 27 shows a create/modify milestone screen 620. Create milestone screen 620 is only available to users with modify permissions. In the embodiment shown, tasks are not selected from an existing template, rather, they are created ad hoc, if the user has modify permissions.

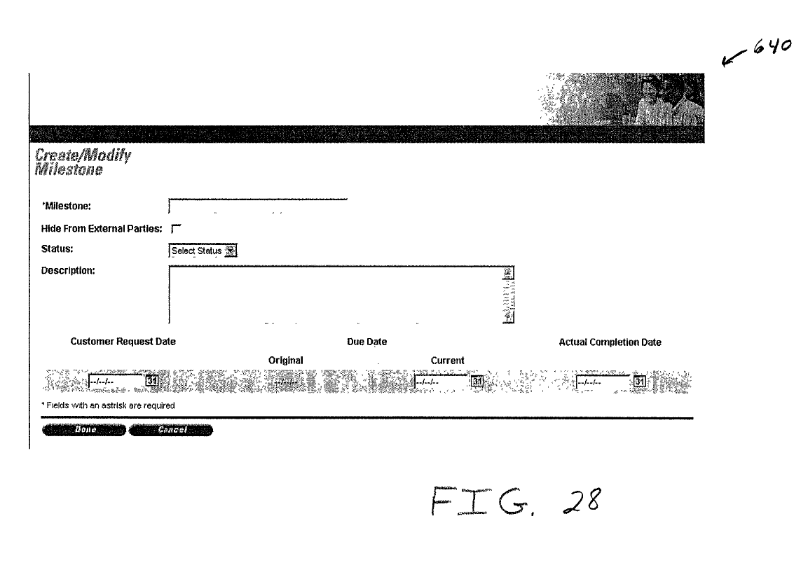

FIG. 28 is a Create/Modify Milestone screen 640 configured for detailed viewing and modifying of milestones in a timeline. Using the interface provided by screen 640, a user with modify permissions is able to modify all detailed information for a single milestone, including customer request dates, due dates, and actual completion dates. Users who without modify permissions use screen 640 as a milestone profile page.

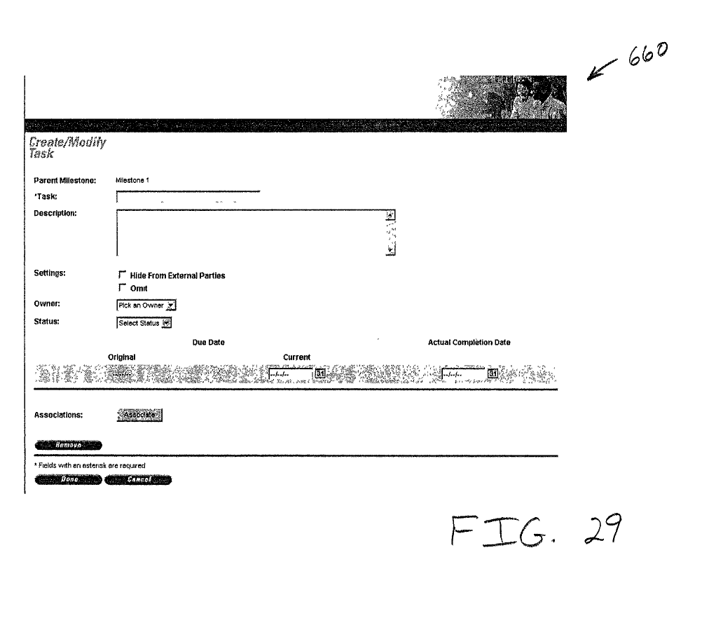

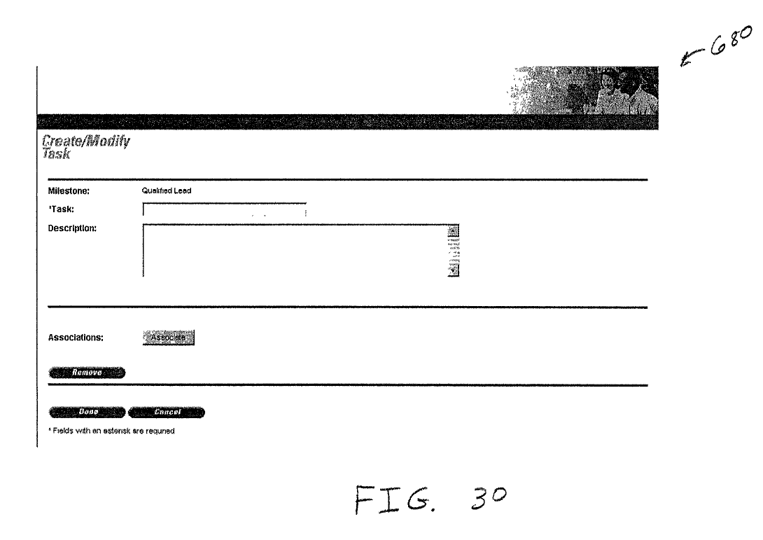

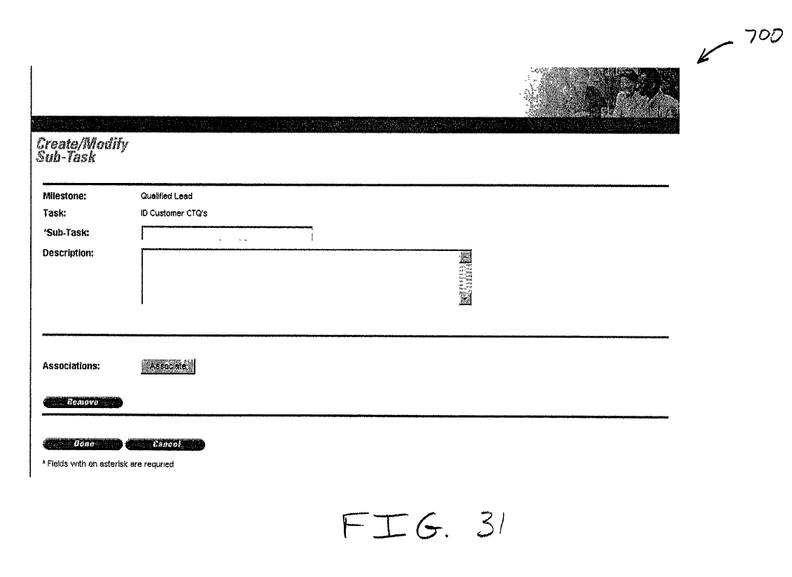

FIG. 29 is a Create/Modify Task screen 660 serves as both a modification and profile screen for tasks. In one embodiment, all active deal users are able to either create new ad hoc tasks. In another embodiment, only users with modify permissions may modify detailed information belonging to an existing task. Users without modify permissions use screen 660 as a detailed profile view of a task. A Create/Modify sub-Task screen (not shown) provides the same functionality for sub-tasks. FIG. 30 shows a create/modify task screen 680 and FIG. 31 shows a create/modify sub-task screen 700 where a user is not able to modify detailed information belonging to the tasks and sub-tasks. However the user, with appropriate permissions is able to associate a created task with a milestone and a sub-task with a task.

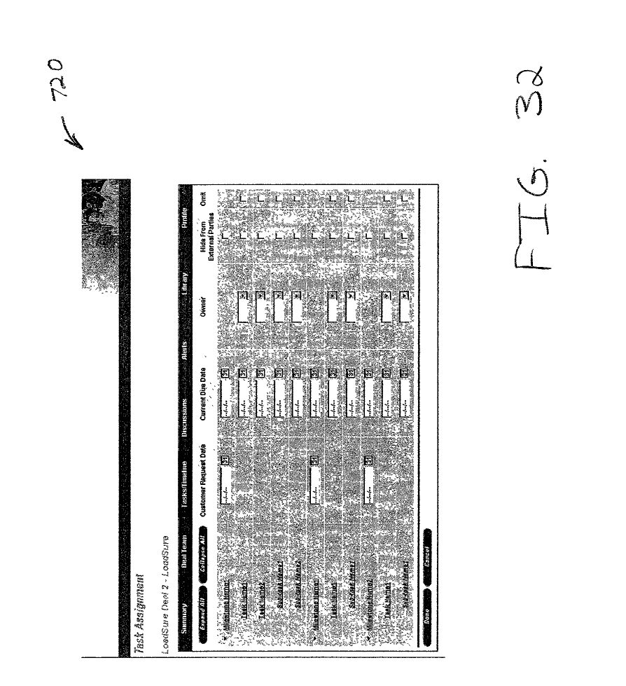

FIG. 32 is an exemplary task assignment screen 720 allows a user to set-up milestones, tasks, and sub-tasks in a time efficient manner. For each milestone a user with modify permissions is able to modify the hide property, current due date and customer request date. A company user can only enter a customer request date once, then that date value is locked. From that point forward only administrator users can change the customer request date. Also for tasks/sub-tasks, a user is able to assign an owner, modify due dates, and set hide and omit values. In one exemplary embodiment, screen 720 is not accessible by users without modify permissions. A Hide From External Parties check box identifies whether or not a milestone/task/sub-task is hidden from the non company party and an omit check box indicates whether or not a task/sub-task is part of the active list of tasks and sub-tasks.

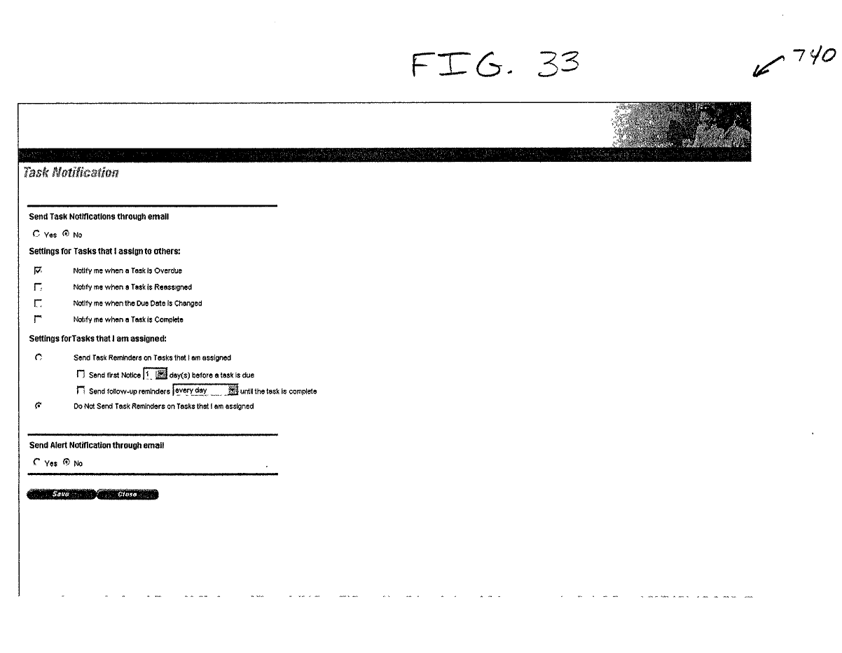

Task Notifications allow users to specify what type of notifications they wish to receive for both tasks that they assign to others and tasks that they are assigned. An exemplary task notifications screen 740 is shown in FIG. 33. Screen 740 provides an ability for each user to specify to receive task notifications through e-mail or only through system generated notifications, based on user preferences. In addition each user is able to specify what events will trigger notifications on tasks, which are assigned to others. For example, notices can be sent when a task is overdue, reassigned, due date is changed, and upon completion. Each user is also able to specify certain conditions that trigger notifications for alerts, which are assigned to them. Notices are sent in advance when a task is due, and then at periodic intervals after the first notice is sent. In one embodiment, users are automatically notified via a system-generated alert when they are assigned a task. All task notifications will appear under the task icon on the summary page (described in FIG. 15). When alerts are sent, the sent by field is the person who assigned the task, allowing reply functionality.

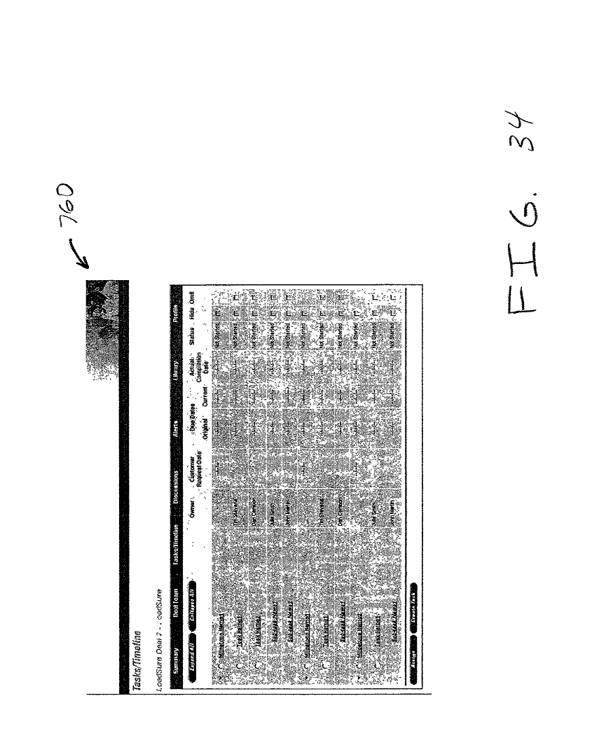

Tasks functionality allows a deal to have a specific structure or process flow managed by key milestones and tasks. Tasks are grouped logically into milestones to allow the team members to gauge the stage the deal is in, along with providing structure to the process and ability to manage tasks. Tasks also give the team members guidance as to what their responsibilities are on the team. FIG. 34 is a tasks screen 760 which allows the user to view all the Milestones, Tasks and sub-tasks that are part of the Tasks section of the deal. If given modify permissions, the user is able to modify existing milestones/tasks/sub-tasks, and assign tasks/sub-tasks to team members. If not given modify permissions, the user is able to only view the milestone, task, and sub-task information. Therefore, no modifications may be made directly on screen 800 other than adding new tasks/sub-tasks and modifying date information. However, if a user has modify permissions, the milestone, task and sub-task links will open Modify Milestone/Task/Sub-task pages.

Included in screen 760 are a customer request date, an original due date which is established the first time that a user enters the Current Due Date, and an actual complete date. This Customer Request Date value is used as the Original Due Date and can only be changed by a system administrator. In one embodiment, milestones are ordered by the order in which they appear on the template, and this order cannot be changed.

Deal Discussions

FIG. 35 is an exemplary create discussion screen 780 used by a deal room participant to create a threaded conversation with other deal team members within system 10. In one embodiment, discussions are deal centered and therefore cannot be accessed by users outside of the deal team. In another embodiment, a user creating a discussion can elect which deal team members are invited to join in the discussion. Purging a discussion requires administrator or manager privileges and purges the discussion from all members who had access to the discussion.

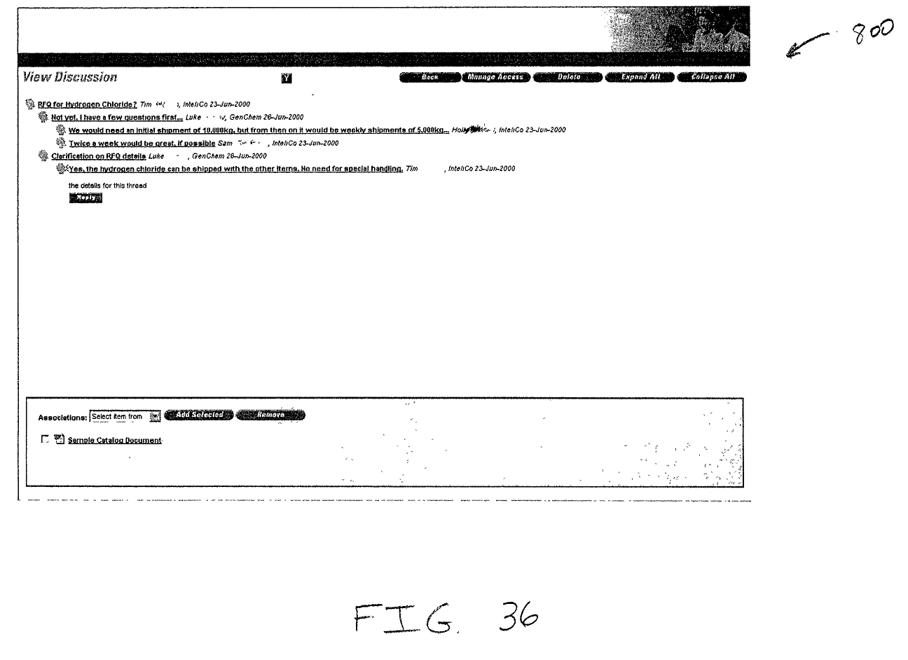

FIG. 36 is an exemplary view discussion screen 800 where a user can review the discussion of other members of the deal team by selecting one of displayed previous comments within the discussion. The user can choose to reply to any of the previous statements within the discussion.

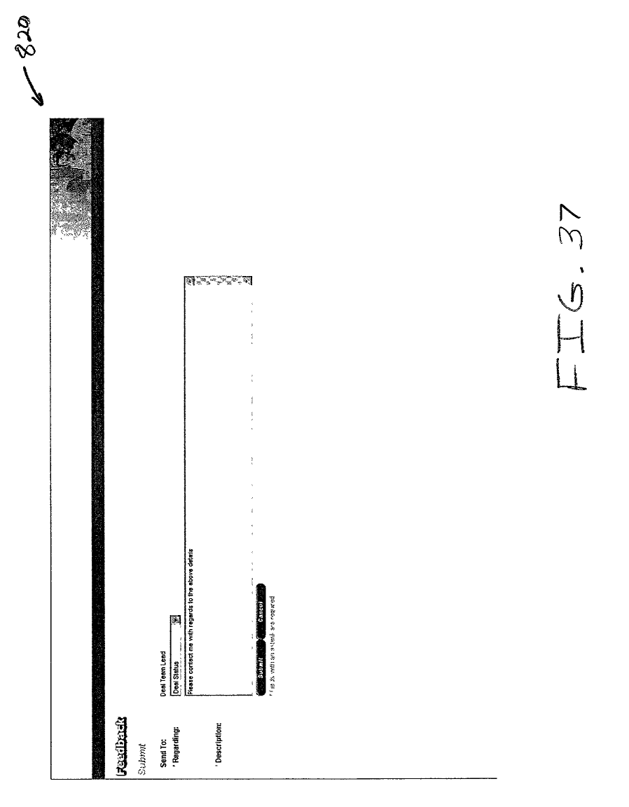

A Voice of Customer (VOC) section provides deal participants a mechanism for providing feedback. Customers are both internal and external. FIG. 37 is a voice of customer submit screen 820 where a customer is able to provide feedback directly from the deal workspace. Any deal team member can access VOC submit screen 820 at all times. In one embodiment, all feedback is submitted in the form of an alert and is recorded as an alert from the person inputting the feedback to the deal team lead. In this embodiment, the feedback is recorded in a table that cannot be edited by anyone else within the deal. In another embodiment, system 10 (shown in FIG. 2) is configured to send an email to a pre-defined, common Quality mailbox for each business, when VOC is submitted.

As shown in screen 820, a send to field defaults to a primary contact on the deal team. A regarding field allows a user to choose from pre-defined feedback areas that, in one embodiment, are selected from a pull down list box. A description field is a free text entry form for feedback comments.

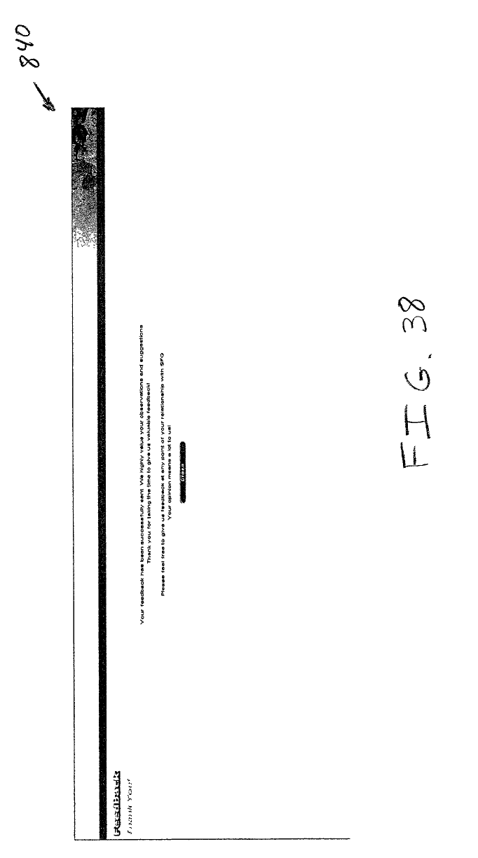

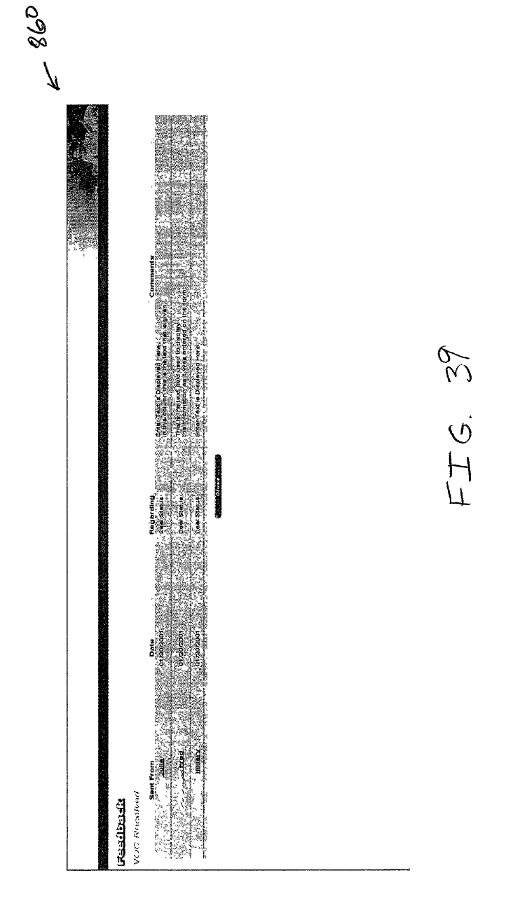

FIG. 38 is an example VOC submitted screen 840, presented to a user to verify that the user's feedback was properly submitted. A VOC summary screen 860, as shown in FIG. 39, is a displayed collection of all feedback that has been submitted for a particular deal. Once a participant submits feedback, screen 860 shows the feedback chronologically. In one embodiment, the summary is accessible from the deal summary screen (described in FIG. 15) for the deal, and will open up in another screen when the button in the profile screen is selected.

Deal Library

A Library provides the ability for deal members to categorize deal related files. Content added to the library can be permissioned to give only specified users access to the item. Permissioned users can browse the deal library and all relevant content. Documents within the library can be viewed along with associated meta-data describing the details of the document via an Index Card feature.

FIG. 40 is an exemplary View Library screen 880 users browse the content specific to a deal based on their permissions for that deal. All deal team members have access to the deal library as well as an ability for all (internal and external) deal team members to post files of any form to the deal library. Each deal library folder structure includes a customer company folder (a master document folder for the customer) and the folder structure determined by the library template application and spans across deals for the specific company. Default permissions on the template folders in the deal library will be driven by the permissions selected when creating the folder in the library templates application (described above in FIG. 16).

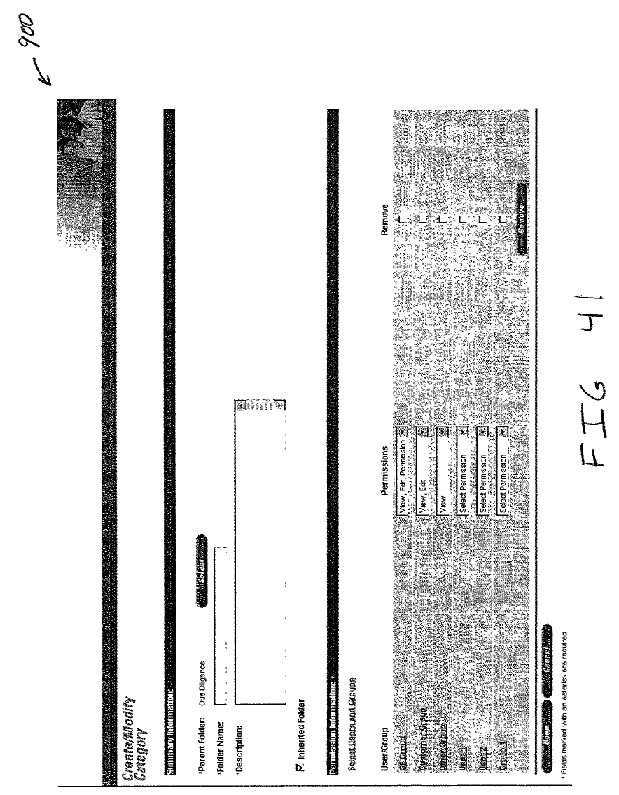

FIG. 41 is a create folder screen 900 allows a user to define a template folder's attributes, select a parent folder, and define the permissions for the folder. In one embodiment, only users with view or edit permissions may access screen 900. In another embodiment, a folder can only have one parent folder and the inherited folder checkbox defaults to selected if the parent folder is an inherited folder. If the parent folder is inherited, the inherited folder checkbox is selected, and the permissions table defaults to the permissions of the inherited folder. If not selected, the permissions table will be empty. Users with appropriate permission levels can add users and groups to the permission table via a select users and groups button. Users with appropriate permission levels are able to add the company group, customer group, and other group to the permissions table from the user/group picker list if the folder is not inherited.

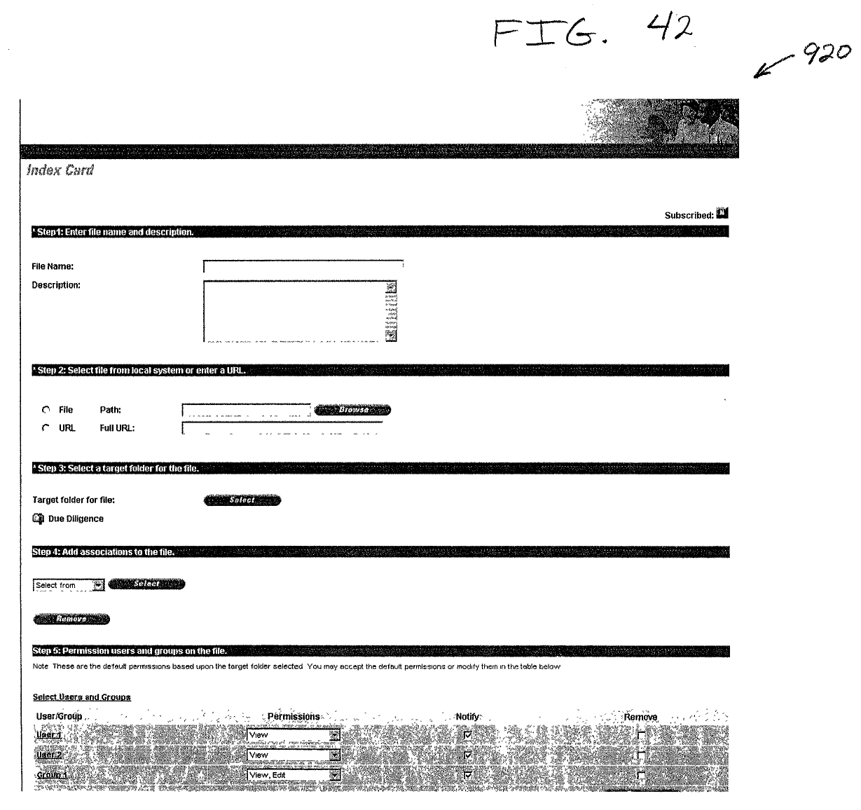

FIG. 42 is an exemplary create index card screen 920 which enables a user to upload and set permissions on a file in the deal library. The upload and permission process is accomplished by the following steps of entering the file name and description, selecting the file, selecting the target folder for the file, adding optional associations and adding permissions. All deal team members may add a document in the deal library and users have the ability to selectively notify users with appropriate permission levels via a system generated notification that the document has been created by selecting Notify checkbox(es) in a table containing permission levels. The Notify checkbox will default to Selected. The System Generated notification is a direct hyperlink to the file that includes the name of the document, the name of the creator, and the date created. When setting permissions on a file, creators are able to select from Deal Team members whom they are have permission to view. Users have the ability to assign one of three file permissions to a user or group. View—enables a user to only View/Download a file, View, Edit—enables a user to view and/or edit a file, and View, Edit, Permission—enables a user to view, edit and permission a document. In one exemplary embodiment, each business's employees can view all documents across all deals, but external users can only view documents they have appropriate permissions to view and add documents; they cannot delete the document once it is in the Library.

A View version of the index card screen (not shown) allows the user to view the summary, version, association, and permission information related to a file. The user does not have the ability to modify any of the information on this screen.

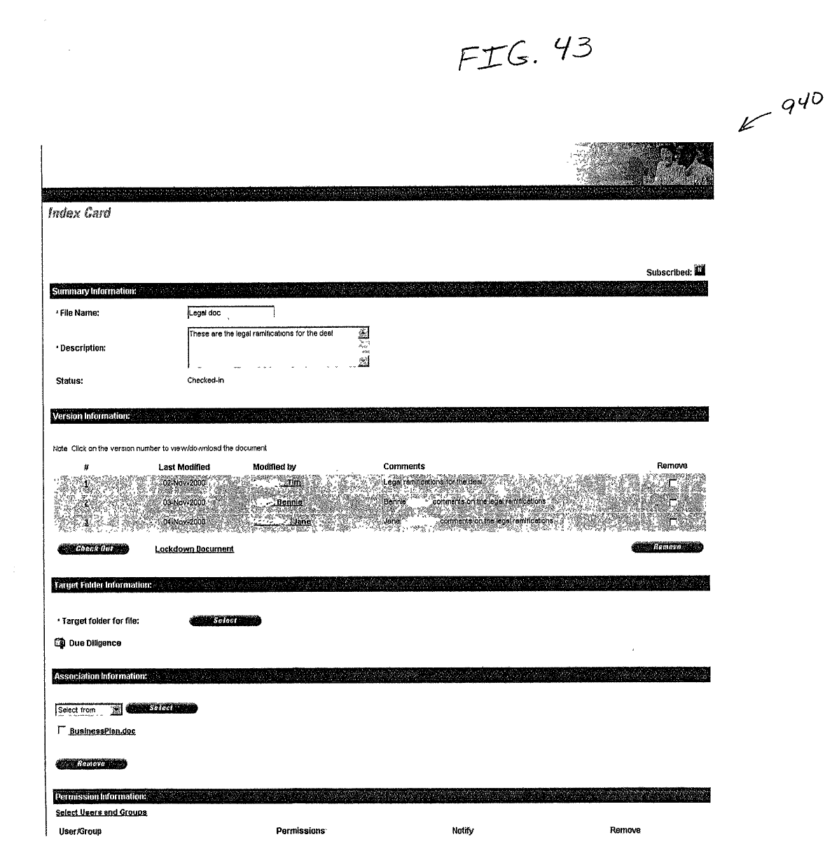

FIG. 43 is an exemplary Modify Index Card screen 940 which allows the user to edit summary, version, target folder, association, and permission information for the file. Administrator users can also remove specific versions of the file, purge old versions of the file, lock down the file, or delete the entire index card.

Deal Profile

A profile contains summary information concerning a deal and are customized for, and vary by, company components. Deal team members have the ability to quickly update or access the particulars of a deal through the profile in the deal space. Users with permissions can also mark a deal as “Confidential” from a profile screen, thereby restricting deal access to only active deal team members. Users can also access any Voice of Customer information for the deal from a profile screen.

In one particular embodiment, a profile screen 960, shown in FIG. 44, within the deal space shows summary information on a deal such as profile, product, and volume information, deal dollar amounts, and access to Voice of Customer information. Users with appropriate permission levels have access to view or modify existing deal information. In one embodiment, non-company users cannot access screen 960.

In another embodiment, once a deal is marked “Confidential” via screen 960, only active deal team members can see the deal. Therefore, if managers and administrator users are not on the deal team, they will not be able to see the deal. Anyone on the deal team can mark a deal as “Confidential”. If deal status is “Dead”, users have the ability to add a description next to the status. A date closed field is populated when the last task or milestone is set to “Closed”.

A selected Division will determine and refresh the values available for the Sub Division. If Business Participation field is set to “Yes”, the user must select a business participation level. By selecting a product, system 10 will determine and refresh the product types. Multiple products can be added to the product table, but products can only be added one at a time.

In one embodiment, the Select Fiscal Year drop down box defaults to the current fiscal year and a user can only view estimates, actuals, and annual totals one fiscal year at a time. Total Funded estimates and actuals column is a calculation of the totals for all fiscal years with estimate and actual entries. Additional fiscal years can be added through the Select Fiscal Year drop down box.

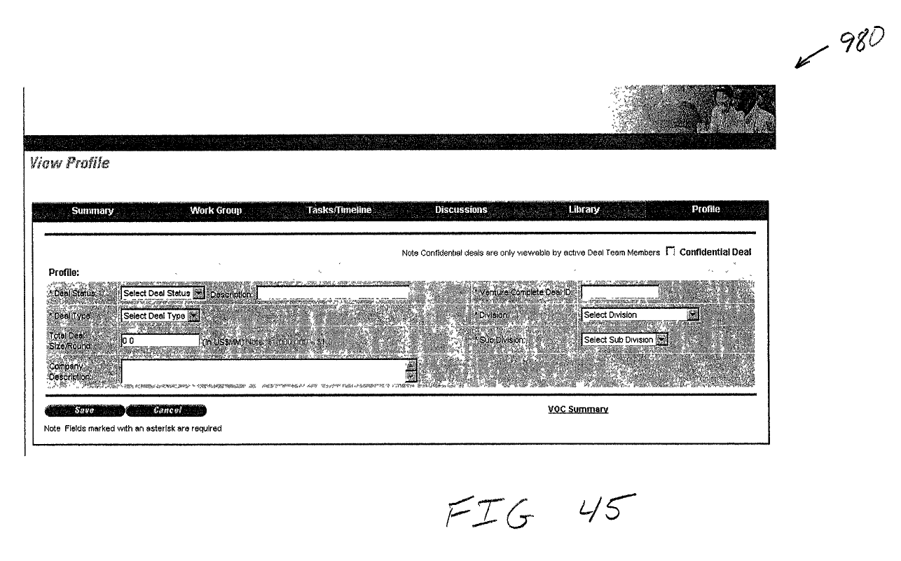

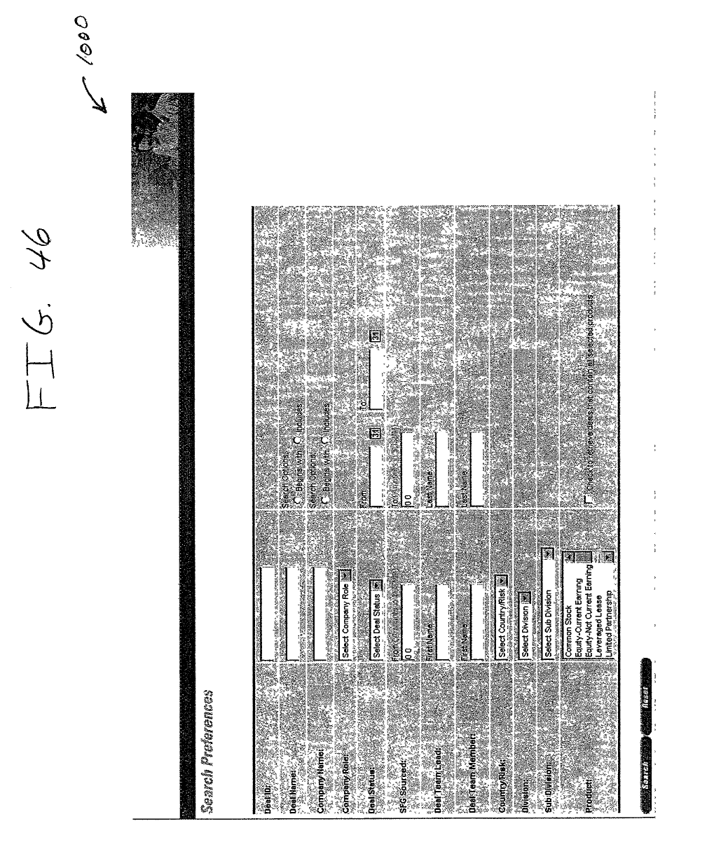

In still another embodiment, a profile screen 980, as shown in FIG. 45 within the deal space shows summary information on a deal such as deal status, description, and deal size. Users with appropriate permission levels have access to view or modify existing deal profile information. Also included is an ability to override default view permissions by making the deal confidential. In one embodiment, only active deal team members are able to see a confidential deal. In another embodiment, screen 980 is not available to non-company users. A time stamp is captured when deal status is set to “Funded”, “Divested”, or “Rejected” in order to utilize the time range criteria on the search preferences screen (described below in FIG. 46). Other deal statuses, in one embodiment include, Active, Inactive, Closed, Dead, Paid Off, Sold and Matured.

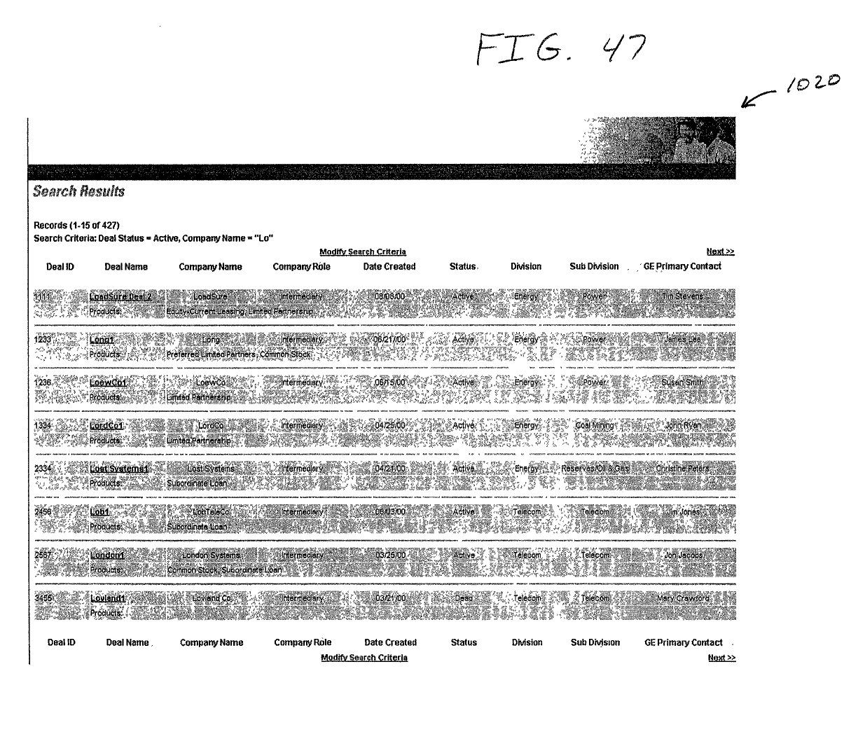

A Search application allows users to search meta-data within the deal and view results based on search criteria. Each business has unique search criteria, and therefore, each have individual Search Preference pages. An appropriate Content Management System (i.e. FileNet) addresses document search capabilities. FIG. 46 is an exemplary example of a deal search preferences screen 1000. Deal search preferences screen 1000, in one embodiment, is used to capture criteria on which users search deals. Users have the option of entering no or multiple criteria to capture a list of deals. Results appear on the deal search results page (described below in FIG. 47) along with the criteria used for the search. All defined search criteria are shown on the search results page regardless of the results of the search. Certain deal information is designated as ‘closed from public access’ (search included) upon designation by a user which such authority. Confidential deals are searchable only by active team members.

Screen 1000 includes a Deal ID number assigned to deal, a Deal Name, a name of client company, a company role, and a deal status showing current status of a deal. If deal status is dead or closed, From/To date range fields are enabled. Screen 1000 further includes a first and last name of the deal team lead. First and last name are separated to have the ability to search by first and/or last name. A country field includes country risk for deals. Screen 1000 includes a product field where the user can select products to search for in deals.

In one exemplary embodiment, deal search preferences for a company include focused sub-string searches on the deal name and company name. Search options include “Begins with” or “Includes” on the search preference page. For Deal Status, when searching for “Active” or “Inactive” deals, date range fields are not enabled. Finally, for Deal Status, when searching for “Closed” or “Dead” deals, date range fields are enabled. Functionality on search page 1000, in one embodiment, assumes “and” functionality with data on the search preferences page.

In another exemplary embodiment, deal search preferences include focused sub-string searches on the deal name and company name. Search options include “Begins with” or “Includes” on deal search preference screen 1000. When searching for “In Process” deals, date range fields are not enabled. Finally for Deal Status, when searching for “Funded”, “Divested”, or “Rejected” deals, the date range fields are enabled.

FIG. 47 is an exemplary deal search results screen 1020. Deal search results provide a report view of deals based on the criteria entered on the deal search preferences page (described above in FIG. 46). Deals are listed with the search criteria and the number of deals returned at the top of the page. In one embodiment, the user can navigate to additional pages of results if more than fifteen are returned. In another embodiment, the default presentation of search results is sorted alphabetical by deal name and there is an ability for the user to sort by criteria columns in search results and the users have ability to drill down on specific deals displayed on search results screen 1020.

In one particular embodiment, if a user searches by company name, search results screen will display company name and company role columns. However, if a user does not search on company name, the search results page will display the primary company column (instead of the company name and company role columns). In another embodiment (not shown), a size of the deal is displayed on screen 1020.

A Document Search feature (not shown) is included in one embodiment and is structured similarly to deal search results screen 1020 (shown in FIG. 47), with an embedded hyper-link on deal results screen 1020. The document search functionality is handled via native search capabilities of an appropriate Content Management System, for example, FileNet and capabilities of the portal, and is configured to perform missing document meta-data searches, search on version and index card comments, as well as the content of the documents and search documents within the deal space without making distinctions for deal status.

Personalized Portals and Web Pages

As described above in FIG. 1 and FIG. 4 prospect contact is accomplished through one or both of personalized portals configured for prospective customers after an initial contact or through prospect web pages configured with data, which, when accessed by a potential customer causes an interest and further investigation into possible deals on their part. In one embodiment, personal portal functionality is enabled by selection of a personal portal option on briefing page 500, shown in FIG. 26. By having a personal portal, a prospect user or a customer user has access to news feeds, templates contacts and tasks. In addition, the user is able to personalize some of the content presented.

FIG. 48 in an exemplary customer invitation screen 1040 which invites the prospect to register as a system user, providing them with a personal portal. Screen 1040 includes an area for the prospect to select their company name, industry templates and provide other user data. Upon registration, the new user is able to select from deal room functions described above, based upon set permissions. Selection of those function is via a customer pull down menu as shown in the figure. FIG. 49 is a continuation of screen 1040 and shows capability for selection of a usemame and password for future portal access.

FIG. 50 is an exemplary embodiment of an Originator Home Page 1100 displayed when an originator logs into system 10. Home page 1100 includes in one embodiment, links to a setup gateway, a customer activity area, resources, a news section, a company status area and a content central area. The setup gateway allows access to common tool for creating and maintaining customer gateways. The customer activity area includes links for generating reports on customer activity. Resources include productivity tools the originator can access and use to improve sales effectiveness. Content central includes links to company tools and tours, case studies and other resources. Company tools, in one exemplary embodiment includes a link to a video demo on a separate page within the website. A further tool is a search tool use to search database attributes and external files including but not limited to html, documents and pdf files.

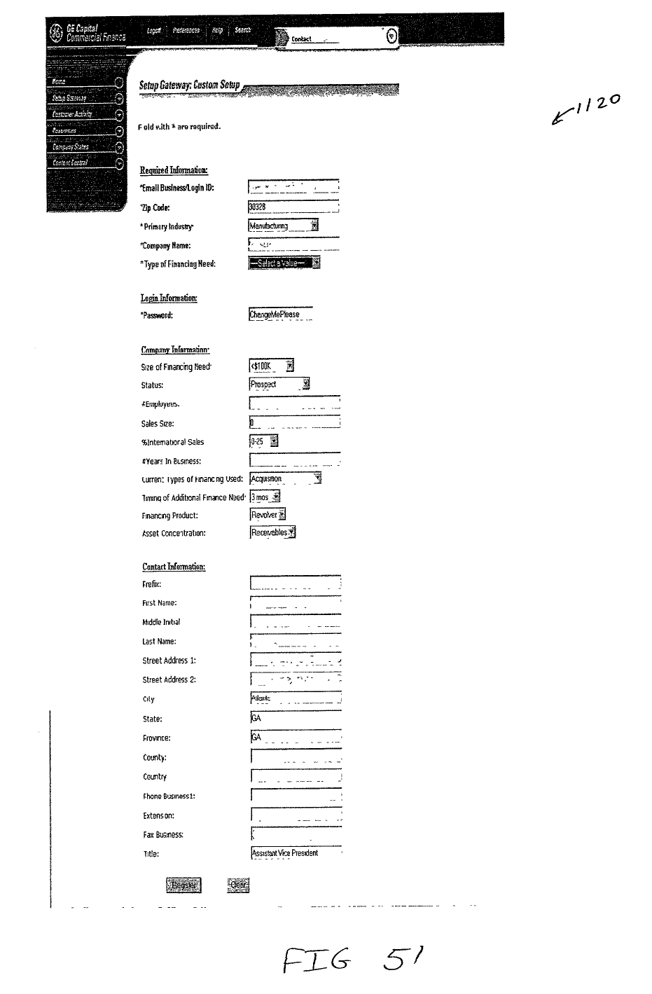

FIG. 51 is an exemplary embodiment of a custom setup page 1120, which is displayed upon selection of a custom setup link on page 1100. Setup page 1120 allows an originator to register prospects and record their profile information for personalizing page content to these prospects. Included are company and contact information including financing needs.

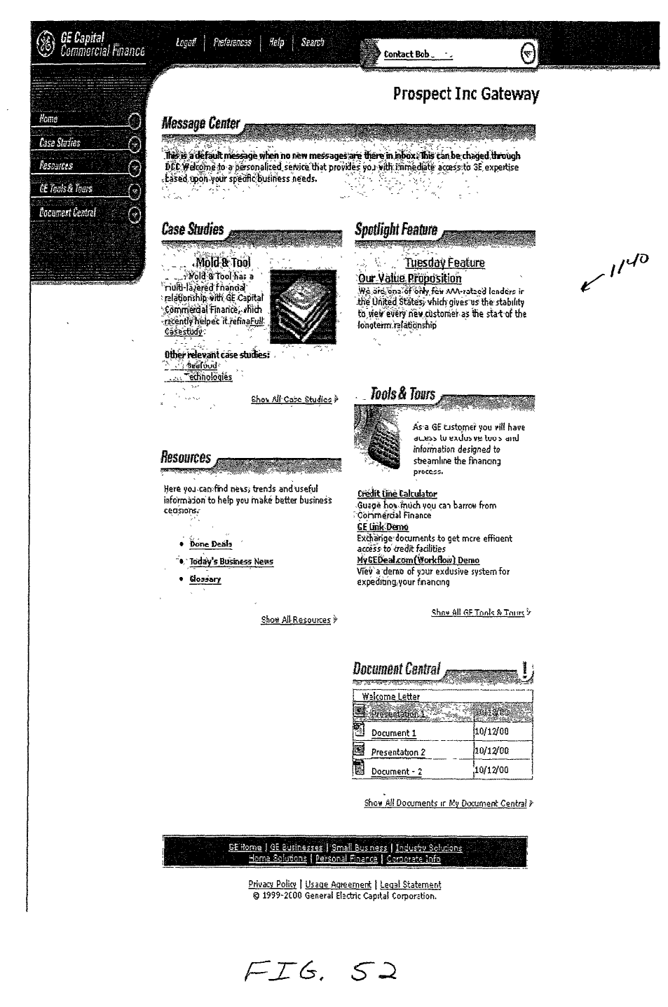

FIG. 52 is an exemplary embodiment of a prospect home page 1140 presented to a prospective customer who chooses to log in. After log in, the prospective customer is allowed to browse the personalized information setup by the Originator, for example, a Message Center to receive alert messages from the Originator or from any background process, Case Studies personalized for the Prospect, Resources where the customer can look at an array of information, for example, interest rates, glossary, business news, frequently asked questions. Company Tools & Tours, for example, presents demos like a credit line calculator and deal video. Spotlight Feature and Document Central where all types of documents may be posted for prospect's review. When Document Central contains no other documents, a default is to contain a Welcome Letter. A preferences image link routes the user to a preferences page (not shown) where the prospect can change their company profile information, for example, address, phone number. Search image link causes a search page (not shown) to be displayed. A help image link shows a help page (not shown). Contact originator link, in one embodiment, opens a small pop-up window with details of the primary originator along with an e-mail address link which enables the prospect to send an e-mail to the primary originator.

The message center is a section where if there are any new alert messages, for example, messages sent by the originator in cases like adding new presentations sent by system 10 when switching from prospect to qualified prospect. If there are no new messages, a default message is displayed. New messages are displayed in a list box. On selection of a new message from the list box, a new window opens which contains the selected alert message. The case studies section displays links to rule based retrieval of case studies set up by the originator for the prospect. Selecting a case opens a window in which the case study is displayed. A link to show all case studies is available, which retrieves and displays all case studies which agree with the rule. If there are no case studies for the prospect, there are default case studies available for selection and display, including, but not limited to, prospect industry, financing needed and region wise. Case Studies are selected by the originator in the custom setup section of the originator page.

Document Central is a combination of presentations and proposals and contains all communications to prospect direct from originator, like new documents or presentations sent to a prospect by an originator. Example of documents in the document center include pitch presentations, configured as a link to the presentation uploaded by the originator, presented to the prospect in a new window.

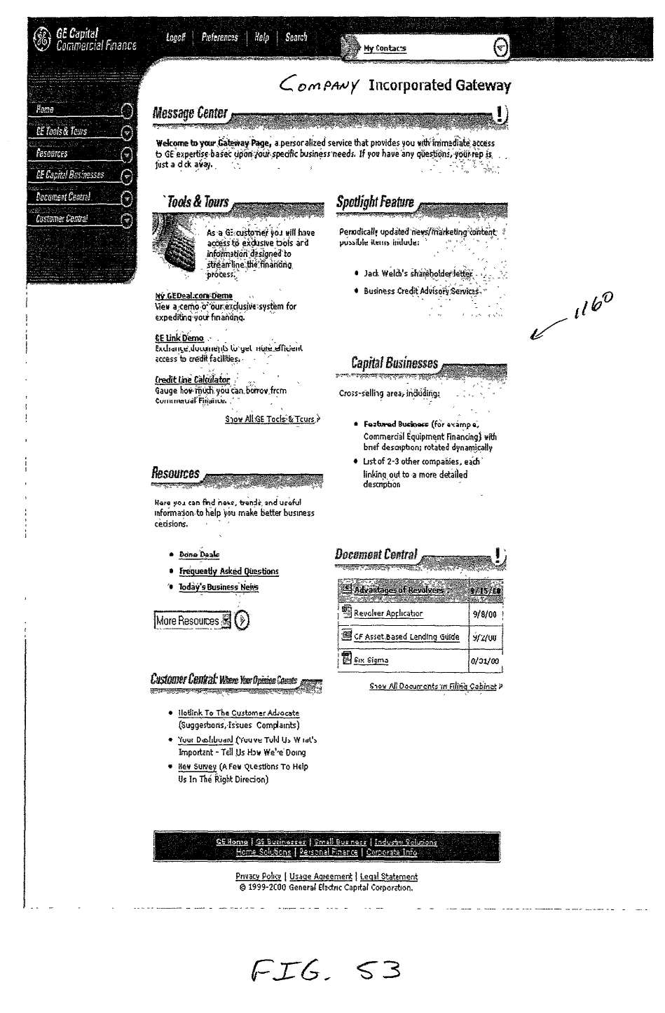

FIG. 53 is an exemplary example of a customer page 1160. Users that access page 1150 include the customer and a Primary Originator/Account Manager in order to preview the settings made by them for the customer and to check functionality, for example, of message links and welcome links. A customer accesses page 1160 in order to browse through the page, select the various links and view the content, send e-mail to the account contacts, search for content in the gateway, customize their preferences and to log off from the site.

Page 1160, in the embodiment shown in the Figure includes a my contacts link, which, in one embodiment, opens a small popup window with details of the primary originator along with an e-mail address link which enables the customer to send an e-mail to the primary originator. In addition, in one exemplary embodiment, and as shown in the figure, the Customer's Company name is shown page 1160.

In one embodiment, page 1160 is divided into various sections, including a message center, company tools & tours, resources, customer central, spotlight feature, company businesses, and document central.

The message center is a section where if there are any new alert messages, for example, messages sent by the originator in cases like adding new presentations sent by work flow when switching from prospect to qualified prospect. If there are no new messages, a default message is displayed. New messages are displayed in a list box. On selection of a new message from the list box, a new window opens which contains the selected alert message.. The company Tools & Tours section shows a number of Tools and Tours, which are allowed to be shown to a customer, as links in the specific sequence set by Originator. If there is no personalized setting for this Customer, then default tools are displayed in a default sequence. The Resources section displays available Resources in a specific sequence set by Originator. If there is no personalized setting for this Customer, then default resources are displayed in a default sequence.

The Customer Central section displays a number of links, one of which enables the customer to send an e-mail to a customer feedback resolution manager. The company businesses section displays a number of the top company businesses per a default sequence (defined by the Content Manager) where the first displayed business is a ‘Featured Business’. At the bottom of the company businesses section there is a ‘Show all Businesses’ link which shows a list of All Businesses page in Content Frame.

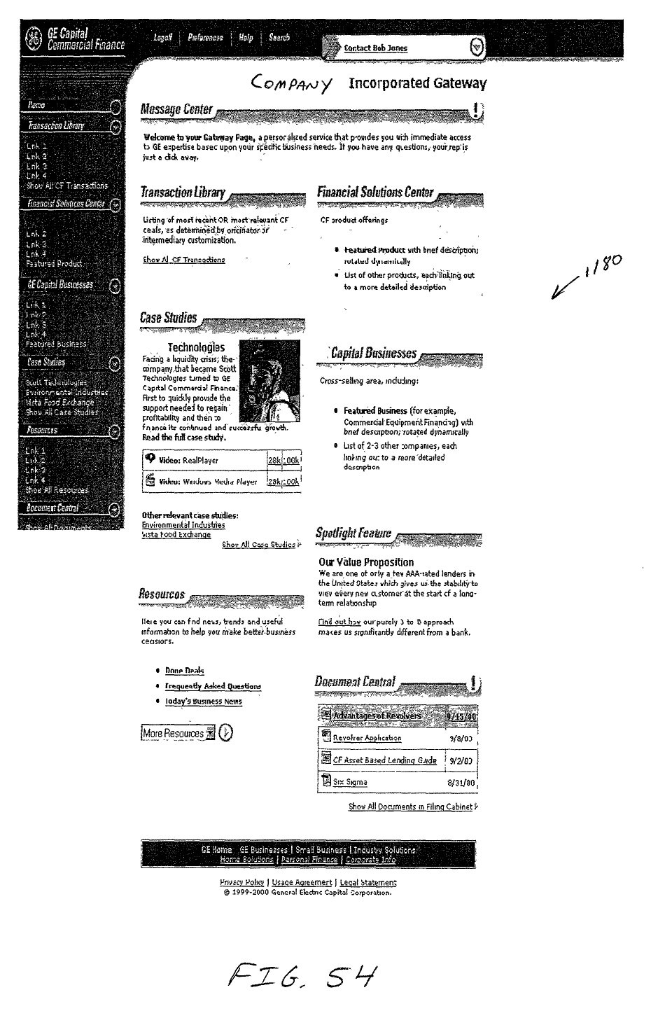

An intermediary page 1180, shown in FIG. 54 includes all of the sections included in customer page 1160 (shown in FIG. 53), and further includes a transaction library where all deals recently closed by the company can be examined. A financial solutions center includes descriptions of financial products offered by the company.

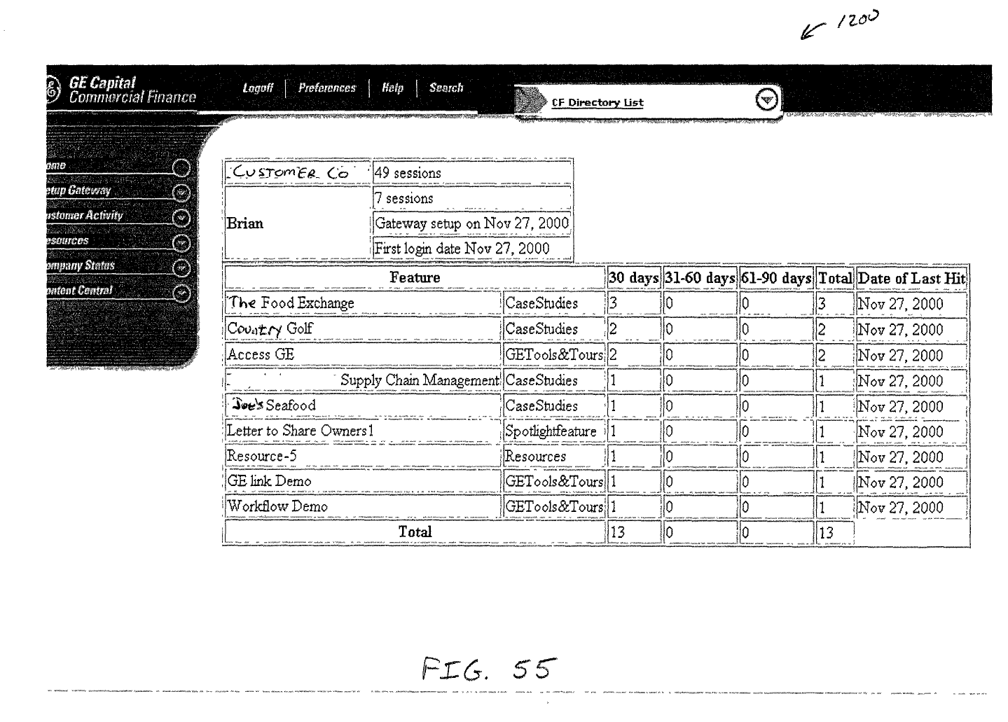

A home page activity report page 1200 shown in FIG. 55 provides a report which indicates which users at which company are accessing their home pages, how often, when and which of the tools and options available on those pages are being accessed.

The methods and systems described above for identifying prospective customers and managing deals provide a commonality amongst transactional businesses which include pooling of resources, sharing of achieved progress and alignment of on going work to bring about cost savings and the leveraging of resources across divisions within a company while also driving a common platform for deal initiation, tracking and processing not found in known systems.

While the invention has been described in terms of various specific embodiments, those skilled in the art will recognize that the invention can be practiced with modification within the spirit and scope of the claims.

What is claimed is:

1. A method for managing a deal process, said method comprising the steps of:
prompting a user to create a business profile;
prompting a user to create a deal, including identifying deal team members; and
notifying members of the deal team of tasks to be performed and milestones.

2. A method according to claim 1 wherein said step of prompting a user to create a business profile further comprises the step of prompting a user to establish user accounts with authority levels of at least one of user, manager, and administrator.

3. A method according to claim 2 wherein said step of prompting a user to create a business profile further comprises the step of prompting an administrator to set up a structure of divisions and sub-divisions for the business.

4. A method according to claim 1 wherein said step of prompting a user to create a deal further comprises the step of prompting a user through one of a personal portal or a personalized web page.

5. A method according to claim 4 wherein said personalized web pages further comprise at least one of an originator page, a prospect page, an intermediary page and a customer page.

6. A method according to claim 4 wherein said step of prompting a user through a personal portal further comprises the step of prompting a user to create at least one of a work group, a my profile and a user profile.

7. A method according to claim 1 wherein said step of prompting a user to create a deal further comprises the step of prompting a user to create at least one of a deal summary, a deal timeline, a deal menu, a deal workspace, a deal discussions area, a deal library and a deal profile.

8. A method according to claim 7 further comprising the step of creating a briefing page, including channels for both company users and non-company users.

9. A method according to claim 1 wherein said step of prompting a user to create a deal further comprises the step of building a library for the deal.

10. A method according to claim 1 wherein said step of notifying members of a deal team further comprises the step of providing a deal status to deal team members.

11. A method according to claim 1 wherein said step of notifying members of a deal team further comprises the step of prompting a user for feedback.

12. A method according to claim 1 wherein said step of notifying members of a deal team further comprises the step of providing capability for at least one of a search of profiles of deal team members, a search across all businesses and a deal search, search results in a format specified by the user.

13. A method according to claim 1 wherein said step of notifying members of a deal team further comprises the step of prompting a user to create or modify at least one of task templates for the deal and library templates for the deal.

14. A method according to claim 1 wherein said step of prompting a user to create a deal further comprises the step of prompting a user to create a customer company profile.

15. A method according to claim 14 wherein said step of prompting a user to create or modify library templates further comprises the step of prompting a user to create or modify an index card functionality used to track information on files uploaded and downloaded from the library.

16. A system comprising:
at least one computer configured as a server, said server containing a database of business rules, libraries and templates for deals for at least one business entity;
at least one client system connected to said server through a network, said server configured to:
prompt a user to create a deal, including identifying deal team members; and
milestones notify members of the deal team of tasks to perform and milestones accomplished.

17. A system according to claim 16 wherein said server is configured with user accounts with authority levels of at least one of user, manager, and administrator.

18. A system according to claim 16 wherein said server is configured with a business structure of divisions and sub-divisions for the business.

19. A system according to claim 16 wherein said server is configured to prompt a user to create a deal through one of a personal portal or a personalized web page.

20. A system according to claim 19 wherein said server is configured with personalized web pages of at least one of a deal originator page, a prospect page, an intermediary page and a customer page.

21. A system according to claim 19 wherein said personal portal comprises an interface to at least one of a work group, a my profile and a user profile.

22. A system according to claim 16 wherein said server is configured with at least one of a deal summary, a deal timeline, a deal menu, a deal workspace, a deal discussions area, a deal library and a deal profile.

23. A system according to claim 16 wherein said server is configured with a briefing page, including channels for both company users and non-company users.

24. A system according to claim 16 wherein said server is configured to assign tasks for members of the deal team.

25. A system according to claim 16 wherein said server is configured to provide deal team members with a deal status.

26. A system according to claim 16 wherein said server is configured to prompt a user for feedback.

27. A system according to claim 16 wherein said server is configured with a search capability for at least one of searching profiles of deal team members, searching across all businesses within a multiple business company, and deal searching.

28. A system according to claim 27 wherein said server is configured to provide search results in a format specified by a user.

29. A system according to claim 16 wherein said server is configured for at least one of prompting a user to create and modify task templates including milestones and tasks for the deal and prompting a user to create and modify library templates for the deal.

30. A system according to claim 16 wherein said server comprises an index card functionality for tracking information on files uploaded and downloaded from a library.

31. Apparatus comprising:
means for a user to create business profiles;
means for storing records of identified business prospects;
means for creating user interfaces for business prospects;
means for storing a status for the business prospects; and
means to facilitate deal processing and tracking by members of a deal team.

32. Apparatus according to claim 31 wherein said means for a user to create business profiles comprises means to set up and maintain user accounts with authority levels of at least one of user, manager, and administrator.

33. Apparatus according to claim 31 wherein said means for a user to create business profiles comprises means to maintain a structure for the business, including creation and modification of divisions and sub-divisions for the business.

34. Apparatus according to claim 31 further comprising means for creating at least one of user accounts through a personal portal or personalized web pages.

35. Apparatus according to claim 31 further comprising means for creating and storing at least one of a deal originator page, a prospect page and a customer page.

36. Apparatus according to claim 31 further comprising means for creating and storing at least one of a work group, a my profile, a user profile and a customer company profile.

37. Apparatus according to claim 31 further comprising means for creating and storing a deal, including least one of a deal summary, a deal workgroup, a deal timeline, a deal menu, a deal workspace, a deal discussions area, a deal library, a deal profile, a deal status and a briefing page.

38. Apparatus according to claim 37 further comprising means for creating and storing milestones and tasks for members of a deal team.

39. Apparatus according to claim 37 further comprising means for creating and storing user feedback.

40. Apparatus according to claim 37 further comprising means for searching profiles of deal team members and searching across all businesses within a multiple business company.

41. Apparatus according to claim 37 further comprising means for searching within the deal and providing search results in a format specified by the user.

42. Apparatus according to claim 37 further comprising means for at least one of creating and modifying and task templates for a deal, creating and modifying library templates for a deal and creating and modifying an index card functionality for tracking information on files uploaded and downloaded from a library.

43. A database comprising:
at least one business profile; and
a plurality of templates for creating library folder structures for association with a deal.

44. A database according to claim 43 further comprising a plurality of task templates for associating milestones and tasks with a deal.

45. A database according to claim 43 wherein said business profile includes at least one division profile for divisions of the business.

46. A database according to claim 45 wherein said division profile includes at least one sub-division profile for a sub-division of the division.

47. A database according to claim 43 further comprising a plurality of at least one of user profiles and customer company profiles.

48. A method for initiating a deal transaction, said method comprising the steps of:
accessing a user interface;
selecting, from the user interface, the initiation of a deal; and
selecting, from the user interface, members of a deal team.

49. A method according to claim 48 wherein said user interface comprises at least one of a personalized user portal and a prospecting web page.

50. A method according to claim 48 wherein said step of selecting deal initiation further comprises the step of causing a deal to be created.

51. A method according to claim 50 wherein said step of causing a deal to be created further comprises the step of selecting at least one of a library template and a task template, including milestones and tasks, for the deal.

52. A method according to claim 50 wherein said step of causing a deal to be created further comprises the step of causing a deal discussion area to be created.

53. A method according to claim 49 wherein said prospecting web page comprises one of an originator page, a prospect page, an intermediary page and a customer page.

54. A method according to claim 48 wherein said step of selecting, members of a deal team further comprises the step of causing a user profile pop-up window to be displayed.

55. A computer-readable medium comprising:
a record of business profiles for a company; and
a plurality of records of library templates and task templates for deal creation;
at least one record of an active deal.

56. A computer-readable medium according to claim 55 wherein said records of library templates comprise library folder structures for association with a deal.

57. A computer-readable medium according to claim 55 wherein said records of task templates comprise milestones, tasks and sub-tasks for association with a deal.

58. A computer-readable medium according to claim 55 wherein said records of business profiles include division profiles and sub-division profiles for the business.

59. A computer-readable medium according to claim 55 further comprising a plurality of user profiles and company profiles.

60. A computer-readable medium according to claim 55 wherein said record of an active deal includes a deal summary.

61. A computer-readable medium comprising:
a record of user interfaces;
a record of user initiated deals; and
a record of deal team members for each deal.

62. A computer-readable medium according to claim 61 wherein said record of user interfaces comprises a record of one of a personalized user portal or a prospecting web page.

63. A computer-readable medium according to claim 61 wherein said record of user initiated deals comprises a selection of at least one of a library template and a task template, including milestones and tasks, for the deal.

64. A computer-readable medium according to claim 61 wherein said record of user initiated deals comprises a record for a deal discussion area for the deal.

65. A computer-readable medium according to claim 62 wherein said record of a prospecting web page comprises a record of at least one of an originator page, a prospect page, an intermediary page and a customer page.

66. A computer-readable medium according to claim 61 wherein record of deal team members further comprises a record of user profiles.

67. A computer programmed to prompt a user with a deal prospect web page.

68. A computer according to claim 67 wherein to prompt a user with a prospect web page, said computer displays a computer generated screen of at least one of an originator page, a prospect page, a customer page and an intermediary page.

69. A computer according to claim 67 wherein to prompt a user with a prospect web page, said computer displays a computer generated screen including a selectable link to at least one of a message center, a company tools and tours screen, a case studies screen, a spotlight feature screen and a resources screen.

70. A computer according to claim 67 programmed to generate a home page activity report page indicating which users at which companies are accessing the prospect web pages, how often the page is accessed, and which tools are being accessed.

71. A computer programmed to prompt a prospect with a customer invitation screen, wherein to prompt the prospect with the customer invitation screen prompts the prospect to register as a user.

72. A computer according to claim 71 wherein to register as a user, said computer displays fields for the prospect to enter at least one of a usemame and a password, providing a portal for future access.

73. A computer according to claim 71 wherein to register as a user, said computer displays fields for the prospect to enter at least one of a company name, an industry template and user data.

74. A computer according to claim 71 further programmed to display to registered users personalized news feeds, templates, contacts and tasks.
